(19) United States
(12) Patent Application Publication
(10) Pub. No.: US 2023/0232848 A1
(43) Pub. Date: Jul. 27, 2023

(54) FUNCTIONALIZED NON-DAIRY BASE AND METHOD FOR PRODUCING NON-DAIRY ANALOGS

(71) Applicant: Eclipse Foods Co., Oakland, CA (US)

(72) Inventors: Amanda Rose Drexler, Oakland, CA (US); Abigail Margaret Jewett, Oakland, CA (US); Thomas Elliot Bowman, Oakland, CA (US)

(21) Appl. No.: 18/126,323

(22) Filed: Mar. 24, 2023

Related U.S. Application Data
(63) Continuation-in-part of application No. 17/705,127, filed on Mar. 25, 2022.
Application No. 17/705,127 is a continuation-in-part of application No. 17/086,252, filed on Oct. 30, 2020.
Application No. 17/086,252 is a continuation of application No. 16/820,502, filed on Mar. 16, 2020.
(60) Provisional application No. 62/874,885, filed on Jul. 16, 2019.
(60) Provisional application No. 62/819,431, filed on Mar. 15, 2019.

(51) Int. Cl. A23C 11/06; A23C 20/02; A23G 9/32; A23G 9/42; A23G 9/34; A23G 9/38

(52) U.S. Cl. CPC A23C 11/06; A23C 20/02; A23G 9/327; A23G 9/42; A23G 9/34; A23G 9/38

(57) ABSTRACT

A method for generating a non-dairy base mixture includes: mixing an amount of salt and an amount of calcium into a volume of water to generate a first mixture; mixing an amount of starches, an amount of plant-extracted proteins, and an amount of stabilizing agents into the first mixture to form a second mixture, the amount of plant-extracted proteins defining a protein ratio corresponding to a target functionality and a target flavor profile; during a blending period, regulating temperature of the second mixture within a first temperature range and blending a volume of oil into the second mixture to form an emulsion; pasteurizing the emulsion at temperatures within a second temperature range and for a target duration; and homogenizing the emulsion at temperatures within a third temperature range to form the non-dairy base mixture configured to form a consumable, non-dairy product exhibiting the target functionality and the target flavor profile.

### CROSS-REFERENCE TO RELATED APPLICATIONS

This application is a continuation-in-part of U.S. patent application Ser. No. 17/705,127, filed on 25 Mar. 2022, which is a continuation-in-part of U.S. patent application Ser. No. 17/086,252, filed on 30 Oct. 2020, which is a continuation of U.S. patent application Ser. No. 16/820,502, filed on 16 Mar. 2020, which claims the benefit of U.S. Provisional Application No. 62/874,885, filed on 16 Jul. 2019, and U.S. Provisional Application No. 62/819,431, filed on 15 Mar. 2019, each of which is incorporated in its entirety by this reference.

### TECHNICAL FIELD

This invention relates generally to the field of food science and more specifically to a new and useful non-dairy base mixture and method for producing non-dairy analogs in the field of food processing.

### BRIEF DESCRIPTION OF THE FIGURES

FIG. 1 is a flowchart representation of a method;

FIGS. 2A and 2B are flowchart representations of the method;

FIGS. 3A and 3B are schematic representations of a base mixture;

FIG. 4 is a flowchart representation of one variation of the method; and

FIGS. 5A and 5B are flowchart representations of one variation of the method;

FIG. 6 is a flowchart representation of one variation of the method;

FIG. 7 is a flowchart representation of one variation of the method;

FIG. 8 is a flowchart representation of one variation of the method;

FIG. 9 is a flowchart representation of one variation of the method;

FIGS. 10A-10C are schematic representations of variation of the base mixture; and

FIGS. 11A and 11B are schematic representations of variations of the base mixture.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Non-Dairy Base Mixture Composition

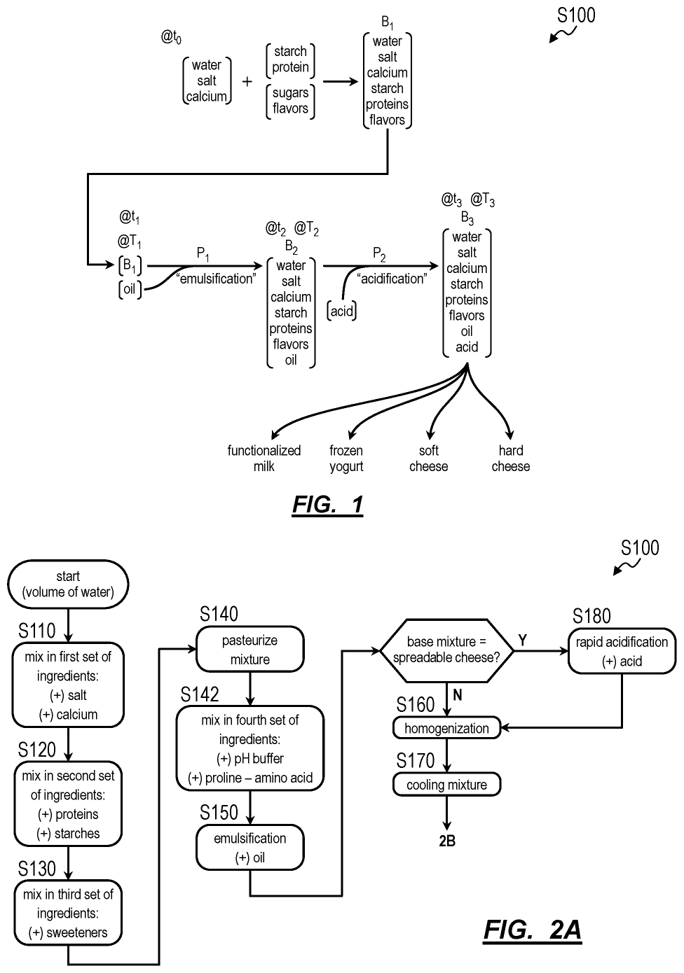

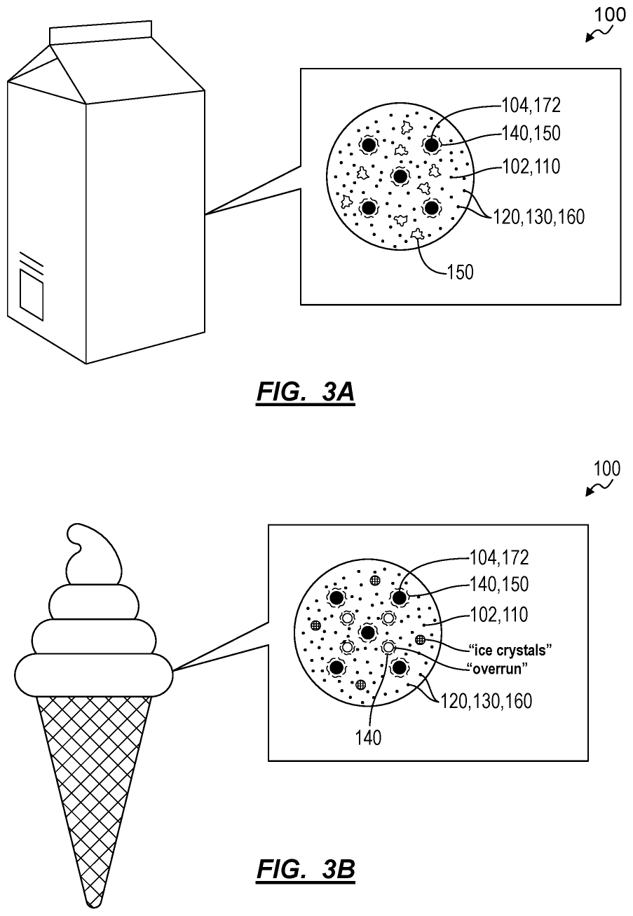

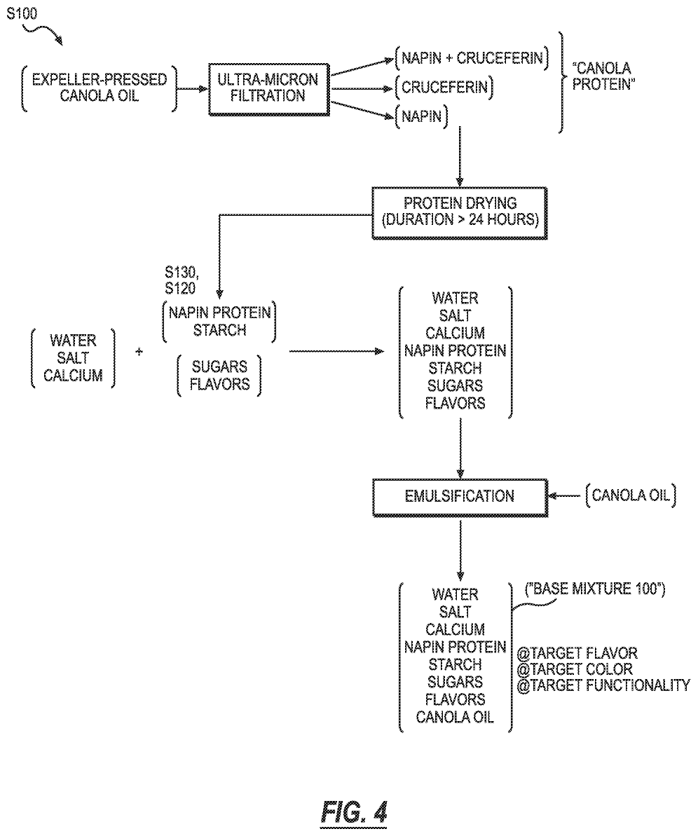

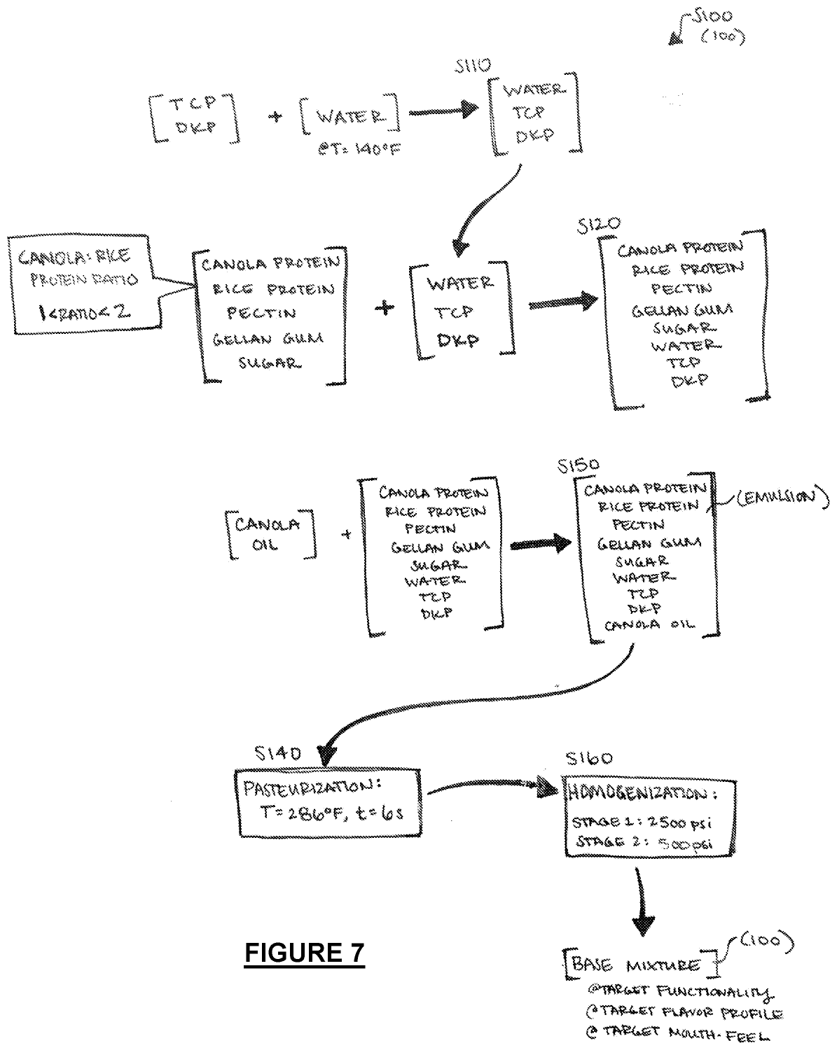

As shown in FIGS. 1, 2A-2B, 3A-3B, 4, 5A-5B, 6-9, 10A-10C, and 11A-11B, a non-dairy base mixture composition (hereinafter a “base mixture composition”) includes: a proportion of water defining an aqueous phase; a proportion of salt dissolved in the aqueous phase; a proportion of calcium dissolved in the aqueous phase; a proportion of plant-extracted proteins configured to form a barrier between the aqueous phase and oil droplets of an oil phase; a proportion of sweeteners; a proportion of fats defining the oil phase and including a volume of oil droplets dispersed throughout the aqueous phase; and a proportion of starches.

In one variation, the base mixture composition includes: a proportion of water; a proportion of salt; a proportion of calcium including calcium lactate and/or calcium gluconate; a proportion of plant-extracted proteins including rapeseed proteins (e.g., canola proteins); a proportion of starches including modified food starches and/or tapioca maltodextrin; a proportion of sweeteners including cane sugar, tapioca syrup, and/or vanilla extract; and a proportion of fats including low-erucic acid rapeseed oil (e.g., canola oil).

### 2. Base Mixture

As shown in FIGS. 1, 2A-2B, 3A-3B, 4, 5A-5B, 6-9, 10A-10C, and 11A-11B, a base mixture 100: includes the base mixture composition; excludes dairy proteins; and is configured to form a set of consumable, non-dairy products (e.g., non-dairy milk, non-dairy frozen dessert, non-dairy yogurt, non-dairy cheese).

As shown in FIGS. 1, 2A-2B, 3A-3B, 4, 5A-5B, 6-9, 10A-10C, and 11A-11B, one variation of the base mixture 100 includes a blend including a proportion of water; a proportion of salt; a proportion of calcium; a proportion of sweeteners; a proportion of starches; and a proportion of plant-extracted proteins. The proportion of plant-extracted proteins: includes a first proportion of canola proteins and a second proportion of secondary proteins; and defines a target ratio of the first proportion of canola proteins to the second proportion of secondary proteins, the target ratio corresponding to a target functionality and a target flavor profile. In this variation, the base mixture 100 further includes a proportion of fats: including a volume of oil droplets dispersed throughout the blend; and configured to cooperate with the proportion of plant-extracted proteins to form an emulsion excluding dairy proteins and configured to form a consumable, non-dairy product exhibiting the target functionality and the target flavor profile corresponding to a target dairy product.

As shown in FIGS. 1, 3A, 3B, and 4, one variation of the base mixture 100 includes: an emulsion (e.g., formed of the base mixture composition) configured to form a set of consumable non-dairy products excluding dairy proteins and including: a proportion of water defining an aqueous phase; a proportion of salt dissolved in the proportion of water; a proportion of calcium dissolved in the proportion of water; a proportion of plant-extracted proteins configured to form a barrier between the aqueous phase and oil droplets of an oil phase; a proportion of starches configured to stabilize the emulsion; a proportion of sweeteners; and a proportion of fats defining the oil phase and including a volume of oil droplets dispersed throughout the aqueous phase and configured to cooperate with the proportion of plant-extracted proteins to form the emulsion.

One variation of the base mixture 100 includes: a proportion of water defining an aqueous phase; a proportion of salt dissolved in the aqueous phase; a proportion of calcium dissolved in the aqueous phase; a proportion of sweeteners; a proportion of fats defining an oil phase including a volume of oil droplets dispersed throughout the aqueous phase; a proportion of Canola proteins configured to form a barrier between oil droplets of the oil phase and the aqueous phase to form an emulsion excluding dairy proteins and configured to form a set of consumable non-dairy products excluding dairy proteins; and a proportion of starches configured to stabilize the emulsion.

One variation of the base mixture 100 includes: a volume of a base mixture 100 includes an aqueous phase 102 including: a proportion of water 110; a proportion of salt 120 dissolved in the proportion of water 110 and configured to solubilize proteins in the aqueous phase 102; a proportion of calcium 130 dissolved in the proportion of water 110; a proportion of proteins 140 configured to form a barrier between the aqueous phase 102 and oil droplets 172 of an oil phase 104; a proportion of starches 150 configured to stabilize the aqueous phase 102 and the oil phase 104; and a proportion of sweeteners 160. The volume of the base mixture 100 further includes the oil phase 104 defining a volume of oil droplets 172 dispersed throughout the aqueous phase 102, immiscible in the aqueous phase 102, and configured to form an emulsion with the aqueous phase 102.

One variation of the base mixture 100 includes: a first proportion of water 110 forming an aqueous phase 102; a first proportion of salt 120 dissolved in the aqueous phase 102; a first proportion of calcium 130 dissolved in the aqueous phase 102; a first proportion of sweeteners 160 dissolved in the aqueous phase 102; a first proportion of fats 170 forming an oil phase 104 and configured to form oil droplets 172 dispersed throughout the aqueous phase 102. The base mixture 100 further includes a first proportion of a protein-starch blend 145 including a first proportion of proteins 140 and a first proportion of starches 150, and configured to: absorb water in the aqueous phase 102; form an interface between the aqueous phase 102 and oil droplets 172 of the oil phase 104 to form an emulsion; and form micelles responsive to acidification of the emulsion. The base mixture 100 further includes a second proportion of starches configured to absorb water from the first proportion of water 110 and stabilize the aqueous phase 102 in the emulsion.

In another variation, the volume of the base mixture 100 includes an aqueous phase 102 including: a proportion of water 110; a proportion of salt 120 dissolved in the proportion of water 110; a proportion of calcium 130 dissolved in the proportion of water 110; a proportion of proteins hydrated by the proportion of water 110 and configured to interact with the proportion of calcium 130 to form micelles; a proportion of starches hydrated by the proportion of water 110; and a proportion of sweeteners. The volume of the base mixture 100 further includes an oil phase 104: including a proportion of fats; immiscible in the aqueous phase 102; and configured to interact with a subset of the proportion of proteins and a subset of the proportion of starches to form an emulsion with the aqueous phase 102.

In one variation, the base mixture 100 further includes: a proportion of a buffer configured to raise a pH of the base mixture 100; and a proportion of an amino acid configured to counter desiccation of the base mixture 100 generated by the proportion of proteins.

### 3 Method

As shown in FIGS. 1, 2A-2B, 3A-3B, 4, 5A-5B, 6-9, 10A-10C, and 11A-11B, a method S100 for generating a non-dairy base mixture 100 (hereinafter “base mixture 100”) includes, during a preparation period: mixing a first set of ingredients to generate a first mixture, the first set of ingredients including a volume of water, an amount of salt, and an amount of calcium in Block S110; and mixing a second set of ingredients into the first mixture to generate a second mixture, the second set of ingredients including an amount of starches, an amount of plant-extracted proteins, and an amount of stabilizing agents configured to stabilize the amount of plant-extracted proteins, the amount of plant-extracted proteins including a first amount of canola proteins and a second amount of secondary proteins mixed at a protein ratio corresponding to a target functionality and a target flavor profile in Block S120. The method S100 further includes, during a blending period succeeding the preparation period: regulating temperature of the second mixture within a first temperature range; and blending a volume of oil into the second mixture to form an emulsion including a dispersion of oil droplets within the volume of water in Block S150. The method S100 further includes: during a pasteurization period succeeding the blending period, pasteurizing the emulsion at temperatures within a second temperature range and for a first duration in Block S140; and, during a homogenization period succeeding the pasteurization period, homogenizing the emulsion at temperatures within a third temperature range and for a second duration to form a base mixture configured to form a consumable, non-dairy product exhibiting the target functionality and the target flavor profile in Block S160.

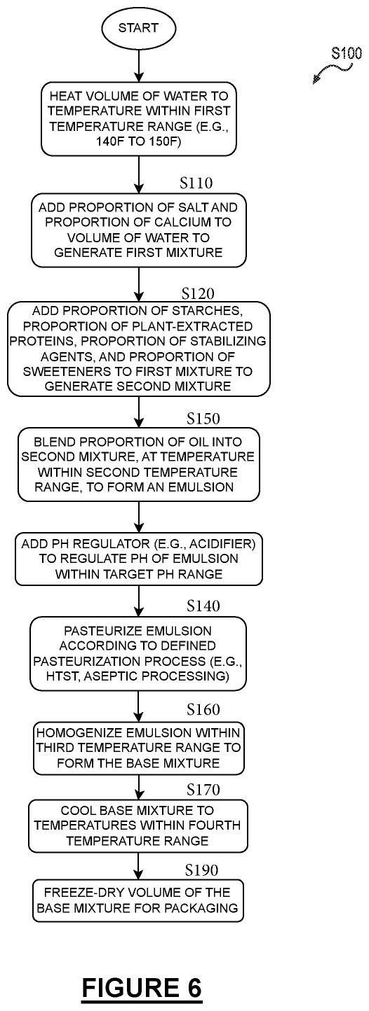

In one variation, as shown in FIG. 6, the method S100 further includes, during a processing period succeeding the homogenization period: spray drying a volume of the base mixture to transform the base mixture from a liquid state to a solid state in Block S190; and packaging the base mixture in the solid state for storage in Block S192.

In one variation, the method S100 further includes, during a second preparation period: mixing a third set of ingredients to generate a third mixture, the third set of ingredients comprising a volume of water, an amount of salt, and an amount of calcium; and mixing a fourth set of ingredients into the third mixture to generate a fourth mixture, the fourth set of ingredients comprising an amount of starches, an amount of plant-extracted proteins, and an amount of stabilizing agents configured to stabilize the proportion of plant-extracted proteins, the amount of plant-extracted proteins comprising a third amount of canola proteins and a fourth amount of secondary proteins mixed at a second protein ratio corresponding to a second target functionality and a second target flavor profile. In this variation, the method S100 further includes, during a second blending period succeeding the second preparation period: regulating temperature of the fourth mixture within the first temperature range; and blending a second volume of oil into the fourth mixture to form a second emulsion comprising a dispersion of oil droplets within the volume of water of the fourth mixture. In this variation, the method S100 further includes: during a second pasteurization period succeeding the second blending period, pasteurizing the second emulsion at temperatures within the second temperature range and for the first duration; and, during a second homogenization period succeeding the second pasteurization period, homogenizing the emulsion at temperatures within the third temperature range and for the second duration to form a second volume of the base mixture configured to form a second consumable, non-dairy product exhibiting the second target functionality and the second target flavor profile.

As shown in FIGS. 1, 2A, 2B, 5A, and 5B, one variation of the method S100 for generating the base mixture 100 includes: treating a volume of water no with a first set of ingredients to form a first mixture in Block S110, the first set of ingredients including salt and soluble in the volume of water 110; mixing a second set of ingredients at a first speed for a first duration into the first mixture to form a second mixture in Block S120, the second set of ingredients including a protein-starch blend; adding a third set of ingredients to the second mixture to form a third mixture in Block S130, the third set of ingredients including sweeteners; pasteurizing the third mixture within a first temperature range and for a second duration in Block S140; blending an oil into the third mixture, regulated within a second temperature range, to form an emulsion including a dispersion of oil droplets 172 within the volume of water 110 in Block S150; homogenizing the emulsion, regulated within a third temperature range, over a third duration to form a base mixture 100 in Block S160; and cooling the base mixture 100 from within the third temperature range to within a fourth temperature range in Block S110.

In one variation, the method further includes: adding an acid to the third mixture, prior to blending the oil into the third mixture, to promote micelle formation between proteins, starches, and the dispersion of oil droplets 172 in the base mixture 100 in Block S180.

In one variation, the method S100 further includes: hydrating the second set of ingredients in the second mixture without shear for a fourth duration; adding a fourth set of ingredients to the third mixture in Block S142, the fourth set of ingredients including a proportion of a buffer configured to raise a pH level of the third mixture and a proportion of an amino acid configured to neutralize tannins present in the second set of ingredients; and storing the base mixture 100 in a chilled environment to inhibit reactions between the second set of ingredients.

Applications

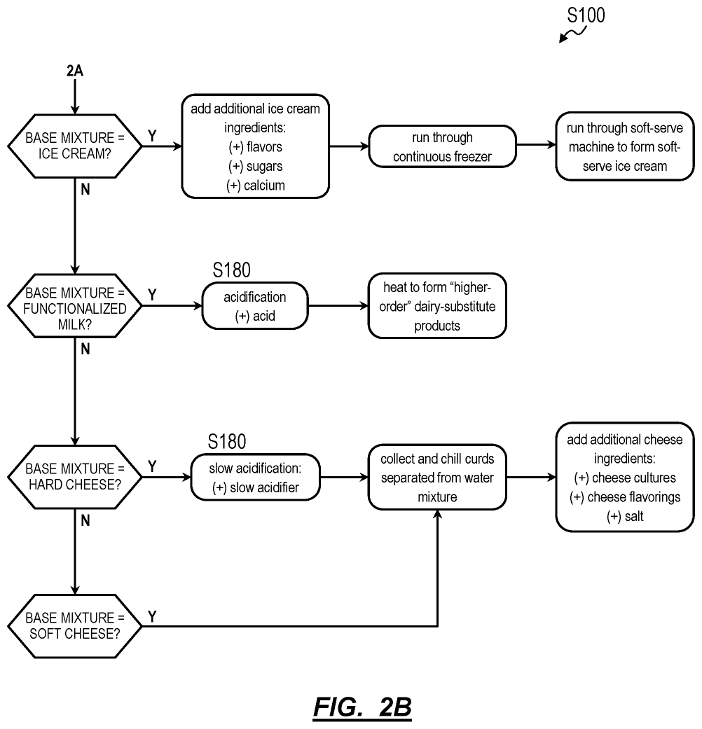

Generally, as shown in FIGS. 2A and 2B, a set of ingredients can be mixed to form a base mixture 100 that can be processed further—according to various food processing techniques and/or in combination with additional ingredients—to form various dairy-alternative end products (e.g., excluding dairy proteins and excluding dairy ingredients), such as: a non-functional milk substitute for direct consumption; a functional milk substitute for baking, for at-home cheese-making, or that may be frothed; non-dairy frozen yogurt; non-dairy ice cream; non-dairy cream cheese; non-dairy soft cheese; non-dairy hard cheese; etc. The base mixture 100 can include: water, salt, starches, sugars, proteins, and calcium. These ingredients can be mixed in particular concentrations designated for the base mixture 100 (or at concentrations designated for a particular end product derived from the mixture) and processed at high sheer to form a homogeneous mixture. These ingredients are then heated to a target temperature and emulsified with oil to reach a stable emulsion exhibiting substantially uniform oil droplet size (e.g., one to ten microns). This addition of oil to the homogeneous aqueous mixture initiates the formation of micelles in the resulting plant-based, non-dairy milk substitute. In particular, the base mixture 100 includes this set of ingredients and is processed to form micelles, which define microscopic structures that include hydrophobic and hydrophilic regions and are formed by aggregate surfactant molecules in aqueous solution, which enable the base mixture 100 to be transformed into many different forms, such as a non-dairy hard cheese, soft cheese, yogurt, cream, spread, ice cream, and/or butter, etc., much like a bovine milk. However, the base mixture 100 can include additional and/or any substitute ingredients to achieve qualities (e.g., taste, texture, functionality) of any other traditional dairy product. For example, the base mixture 100 can be configured to form a consumable, non-dairy product (e.g., non-dairy milk, non-dairy cream, non-dairy frozen dessert, non-dairy spreadable cheese) exhibiting a target flavor profile, a target texture profile, and/or a target color profile (or “pigment profile”) corresponding to a traditional dairy product.

Therefore, these ingredients can be combined in a particular sequence, at specific temperatures, and under particular conditions according to the method in order to enable and control micelle formation within the resulting base mixture 100. In particular, rather than rely on micelles that are naturally present—in varying concentrations—in bovine milk (or milk from other animals) for functionality, and rather than filter or mix large batches of bovine milk in order to achieve consistent micelle concentrations across bovine milk products, the ingredients of the base mixture 100 can instead be combined according to the method to yield any volume of base mixture 100 (e.g., from 10 grams to 10 cubic meters) with a consistent concentration (e.g., +/−0.1% by volume) of micelles.

Following micelle formation, this mixture can be homogenized in order to prevent phase separation and form a functionalized non-dairy base mixture 100. This functionalized non-dairy base mixture 100 can then be packaged and served directly to consumers, who may then froth (e.g., for coffee products), bake with, or make cheese with this functionalized non-dairy base mixture 100 in place of bovine milk (or milk from another animal). Additionally or alternatively, this functionalized non-dairy base mixture 100 can be selectively processed—such as with acidification or refrigeration processes—according to the method in order to form other end products, such as: non-dairy ice cream; non-dairy cream cheese; non-dairy soft cheese; and non-dairy hard cheese.

For example, the base mixture 100 can include both an aqueous phase 102 and an oil phase 104, due to the addition of oil during emulsification of the base mixture 100. Starches present in the base mixture 100 stabilize the aqueous phase 102 of the base mixture 100 and thus maintain components of the mixture in a homogeneous suspension. A cassava base starch in the base mixture 100—which can exist in both the aqueous phase 102 and oil phase 104—stabilizes fats in the oil. Proteins, which include both hydrophobic and hydrophilic tails, bind to both the aqueous phase 102 and the oil phase 104 in the mixture, thus forming a protective shell (or “barrier”) between oil droplets 172 of the oil phase 104 and water and other components of the aqueous phase 102. This combination of proteins and starches thus enable emulsion of the oil into the aqueous phase 102 of the base mixture 100 via dispersion of oil droplets 172 throughout the aqueous phase 102 and to form a homogeneous mixture.

When the base mixture 100 (or emulsion) is acidified—such as by addition of lactic or citric acid, the proteins expel both water and oil and seek starches that are currently bound to oils in the emulsion. The starches in the water phase thus separate to yield an aqueous phase 102 with salts, sugars, and starches. The resulting functionalized base mixture 100 can then be: chilled and processed in an ice cream machine to form ice cream; chilled, further acidified, and treated with an appropriate culture to form frozen yogurt; further chilled to form whipped topping; heated and further acidified before being chilled to form soft cheese (e.g., a mozzarella, cream cheese); or heated, further acidified, chilled, and then aged to form a hard cheese. These end products may therefore form non-dairy alternatives to traditional dairy products that exhibit similar functionalities, textures, stiffness, viscosities, thermo-reversibilities, and meltabilities as their dairy counterparts.

The base mixture 100 can be mixed to include additional ingredients—such as waxy maize, tapioca maltodextrin, natural flavors, and/or bioavailable trace minerals—such that resulting end products exhibit similar flavors and functionalities as their dairy counterparts.

Base Mixture

The base mixture 100 can be processed to produce a set of end products (e.g., non-dairy end products)—such as frozen yogurt (e.g., a non-dairy frozen “yogurt”) or a hard cheese (e.g., a non-dairy hard “cheese”). In particular, the base mixture 100 can be modified to produce various “higher-order” dairy-substitute products including: functional milk (e.g., a non-dairy milk product processed to form micelles that enable transformation into cheese); soft-serve ice cream; hard-packed ice cream; yogurt; whipped cream; spreadable cheeses; soft cheeses; and/or hard cheeses; etc.

Generally, (substantially) regardless of end product, the base mixture 100 includes a base set of ingredients including: water, salt, calcium, starches, proteins, sugars, and fat (e.g., oil). The base mixture 100 can be adjusted to include varying concentrations of each of these ingredients based on designated end product. In one implementation, the base mixture 100 includes: a proportion of water 110; a proportion of salt 120; a proportion of calcium 130; a proportion of starch; a proportion of protein; a proportion of sugar; and a proportion of fat (e.g., oil). Depending on the end product, these proportions may be adjusted.

For example, a first batch of the base mixture 100—configured to generate whipped cream—can include: a first proportion of water no, a first proportion of salt 120, a first proportion of calcium 130, a first proportion of starch, a first proportion of protein, a first proportion of sugar, and a first proportion of oil. A second batch of the base mixture 100—configured to generate ice cream—can include: a second proportion of water, a second proportion of salt, a second proportion of calcium, a second proportion of starch, a second proportion of protein, a second proportion of sugar, and a second proportion of oil, the second proportion of salt greater than the first proportion of salt 120. A third batch of the base mixture 100—configured to make cheese—can include: a third proportion of water, a third proportion of salt, a third proportion of calcium, a third proportion of starch, a third proportion of protein, a third proportion of sugar, a third proportion of oil, and a first proportion of acid, the third proportion of salt greater than the second proportion of salt. The third batch of the base mixture 100 includes a first proportion of acid, configured to promote micelle formation within this mixture. Additionally, the proportion of salt 120 (e.g., salt content) of the base mixture 100 may be adjusted between the three batches in order to regulate protein gelation and thus regulate a firmness of a resulting end product.

In one implementation, a single base mixture 100 can be developed and functionalized initially with one common set of target concentrations for its ingredients regardless of a designated end product. Additional ingredients may then be added to this base mixture 100 in order to prepare the base mixture 100 for transformation into a particular non-dairy end product, such as by adding additional salt to prepare the base mixture 100 for transformation into a soft-serve ice cream or adding an acid to prepare the base mixture 100 for transformation into a cheese. Therefore, a (large) volume of the base mixture 100 can be divided into multiple subvolumes, each of which may correspond to a particular end product and may be incorporated with additional ingredients and processed further to form other non-dairy substitutes.

For example, the base mixture 100 can initially include: a first proportion of water 110, a first proportion of salt 120, a first proportion of calcium 130, a first proportion of starch, a first proportion of protein, a first proportion of sugar; and a first proportion of oil. The base mixture 100 can be divided into a first subvolume designated to make whipped cream, a second subvolume designated to make soft-serve ice cream, and a third subvolume designated to make hard cheese. The first subvolume of the base mixture 100—designated to make whipped cream—can be set aside and processed to generate whipped cream accordingly. The second subvolume—designated to make ice cream—can be adjusted to further include: a second proportion of salt configured to limit hardening of a soft-serve ice cream end product; and a second proportion of sugars configured to promote freezing point depression of the soft-serve ice cream end product. The third subvolume of the base mixture 100—designated to make hard cheese—can be further adjusted to include a third proportion of salt and a first proportion of an acid configured to promote micelle formation in the third subvolume.

Similarly, the base mixture 100: can define a functional non-dairy milk substitute that may be consumed directly in place of animal (e.g., bovine) milk (e.g., in place of skim, 2%, or whole milk); and can serve as a starting point for producing other non-dairy products. For example, a consumer may: purchase a carton of the functional milk product from a grocer; acidify all or a portion of this volume of the functional milk substitute; add a coagulant to the acidified functional milk substitute to trigger curdling; cut the resulting curd; stir, cook, and wash the curd; draw water from the curds; and salt and age the resulting mass, thereby transforming the functional milk substitute into a (hard) cheese at home, such as in a residential kitchen with a microwave or residential stove. Alternatively, the base mixture 100—as a functional milk substitute—can be similarly processed in a factory setting to form cheese.

Alternatively, different base mixtures 100 containing different concentrations of the base ingredients can be produced and functionalized according to the designated end product. For example, in this implementation, a volume of the base mixture 100 designated for a soft-serve ice cream can be mixed and emulsified with a higher initial salt concentration than a volume of the base mixture 100 prepared for a non-functional milk.

5.1 Base Mixture Properties

The base mixture 100 can be configured to exhibit features that correspond to taste, texture, and characteristics of corresponding dairy products. For example, the base mixture 100 can include ingredients at particular concentrations such that—when fully processed to generate a particular non-dairy end product corresponding to a traditional dairy product—the base mixture 100 mimics the taste, texture, and characteristics of the traditional dairy product. The base mixture 100 can be configured to exhibit features similar to traditional dairy products such as: hardness and/or firmness, melting temperature range, freezing point range, freezing point depression, percent overrun, oil droplet size, oil droplet distribution, sweetness, etc.

Additionally, the functionalized base mixture 100 exhibits features that enable the functionalized base mixture 100 to behave similarly to dairy milk. More specifically, the base mixture 100 includes an aqueous phase 102 and an oil phase 104 emulsified into the aqueous phase 102. The aqueous phase 102 includes water, starches, sugars, salts, and other solid ingredients. The oil phase 104 includes fats, starches, and proteins binding to these fats. Starches present in the aqueous phase 102 stabilize the base mixture 100 and function to maintain a homogeneous suspension of solid particles (e.g., ingredients) in the aqueous phase 102, thus preventing phase separation.

### 6. Base Mixture Composition

As shown in FIG. 1, the base mixture 100 is a homogeneous mixture of an aqueous phase 102 defining a homogeneous suspension of solid particles and an oil phase 104 defining a volume of oil droplets 172 approximately uniformly distributed throughout the aqueous phase 102.

Generally, the base mixture 100 includes a volume of water 110 and a set of ingredients added to the volume of water 110. The set of ingredients includes: a first proportion of salt 120, a first proportion of calcium 130, a first proportion of protein 140, a first proportion of starch 150, a first proportion of sweeteners 160 (e.g., sugar), and a first proportion of fats 170.

The base mixture 100 defines an aqueous phase 102 including: the first proportion of salt 120, the first proportion of calcium 130, the first proportion of proteins 140, the first proportion of starches 150, and the first proportion of sweeteners 160. The base mixture 100 further defines an oil phase 104 including a first proportion of fats dispersed within the aqueous phase 102. The base mixture 100 can be processed to form a homogeneous mixture including each of these ingredients.

The base mixture 100 can also include additional ingredients such as: oat fiber; waxy maize; tapioca maltodextrin; natural flavors; bioavailable trace minerals; L. Glutamine; a set of amino acids; octanoic acid; and/or di-potassium phosphate.

In one example, the base mixture 100 includes: a proportion of water; a proportion of salt; a proportion of calcium (e.g., including calcium lactate and/or calcium gluconate); a proportion of plant-extracted proteins including rapeseed proteins (e.g., canola proteins); a proportion of starches including modified food starches and/or tapioca maltodextrin; a proportion of sweeteners including cane sugar, tapioca syrup, and/or vanilla extract; and a proportion of fats including low-erucic acid rapeseed oil (e.g., canola oil). In this example, this base mixture can be pasteurized, emulsified, homogenized, and/or cooled according to Blocks of the method S100 as described above. The base mixture 100 can then be stored (e.g., refrigerated) and/or consumed as a non-dairy milk product (e.g., a non-dairy milk-substitute product).

Additionally and/or alternatively, additional ingredients can be added to the base mixture 100 and/or additional processing can be implemented to generate additional non-dairy products from this non-dairy milk-substitute product.

For example, the base mixture 100 can also include a proportion of amino acids configured to impart a particular set of features—such as related to functionality, digestibility, and/or flavor—to the resulting base mixture 100, such that the resulting base mixture 100 exhibits a target functionality, digestibility, and/or flavor profile. Additionally and/or alternatively, in another example, the base mixture 100 can also include a proportion of di-potassium phosphate configured to prevent phase separation of the aqueous phase and the oil phase of the base mixture 100. Additionally and/or alternatively, in yet another example, the base mixture 100 can also include a proportion of sodium octanoate configured to stabilize the proportion of proteins 140 in the base mixture 100.

In one implementation, the base mixture 100 can include: a proportion of water defining a first concentration between 60 percent and 95 percent by weight; a proportion of salt defining a second concentration between zero percent and 1 percent by weight; a proportion of calcium defining a third concentration between zero percent and 1 percent by weight; a proportion of sweeteners defining a fourth concentration between zero percent and 20 percent by weight; a proportion of starches defining a fifth concentration between zero percent and 3 percent by weight; a proportion of plant-extracted proteins (e.g., canola proteins, chickpea proteins, pea proteins, rice proteins) defining a sixth concentration between 1 percent and 5 percent by weight; and a proportion of fats defining a seventh concentration between 2 percent and 15 percent by weight. Additionally and/or alternatively, in this implementation, the base mixture 100 can further include: a proportion of stabilizing agents—configured to stabilize the proportion of plant-extracted proteins—defining an eighth concentration between zero percent and 2 percent by weight; a proportion of flavorings—configured to modify a flavor profile of the base mixture 100—defining a ninth concentration between zero percent and 2 percent by weight; and/or a proportion (e.g., a trace amount) of a pH adjuster (e.g., an NaOH solution) configured to regulate a pH of the base mixture 100.

In the preceding implementation, each of these concentrations can be modified based on the target non-dairy product (e.g., non-dairy milk, non-dairy ice cream, non-dairy yogurt, non-dairy cheese)—and/or based on target characteristics (e.g., functionality, flavor, mouth-feel) defined for the target non-dairy product—formed of the base mixture 100.

In one example, the proportion of plant-extracted proteins can be configured to impart a particular flavor, texture, and/or functionality to the base mixture 100. In particular, at relatively higher concentrations (e.g., 5 percent by weight), the proportion of plant-extracted proteins can impart: increased plant-protein flavor to the flavor profile (e.g., a grassy flavor profile); a less smooth or variable texture; and/or an increased functionality, such as characterized by increased foaming capability. Alternatively, at relatively lower concentrations (e.g., 1 percent by weight), the proportion of plant-extracted proteins can impart: reduced plant-protein flavor to the flavor profile (e.g., a less grassy flavor profile); a smoother texture or mouth-feel; and/or reduced functionality, such as characterized by reduced foaming capability. In another example, the proportion of fat can be configured to impart a particular texture and/or flavor profile to the base mixture 100. In particular, at relatively higher concentrations (e.g., 8 percent by weight), the proportion of fat can impart: a creamy and rich mouth-feel and/or flavor profile; increased stability of structured foams; and/or increased emulsifier capabilities. Alternatively, at relatively lower concentration (e.g., 2 percent by weight), the proportion of fat can impart: reduced flavor to the flavor profile; a thinner and/or less creamy mouthfeel; and/or decreased stability of foams characterized by loose and/or textured foams. In yet another example, the proportion of stabilizing agents can be configured to impart a particular texture and/or stability to the base mixture 100. In particular, at relatively higher concentrations (e.g., 2 percent by weight), the proportion of stabilizing agents can impart increased stability to the base mixture 100. Alternatively, at relatively lower concentrations (e.g., zero percent by weight), the proportion of stabilizing agents can impart reduced stability—and therefore a thinner texture due to instability of proteins and fats—to the base mixture 100.

6.1 Salt

The base mixture 100 includes a first proportion of salt 120 dissolved in a volume of water 110. Salt is initially added to water to form an aqueous salt-water mixture configured to hydrate proteins and starches of a protein-starch blend and promote unfurling of proteins. The base mixture 100 thus includes salt to promote unfurling of proteins in an aqueous mixture of salt and calcium prior emulsifying oil into the aqueous phase 102.

Additionally, the base mixture 100 can include salt to prevent proteins in the base mixture 100 from forming a solid gel. The salt content can be adjusted to regulate an extent of protein gelation and a consistency of an end product produced by the base mixture 100. Thus, the base mixture 100 can include different concentrations of salt for different end products to adjust consistency and texture of the base mixture 100 for a particular end product. For example, if the base mixture 100 designates whipped cream (i.e., a non-dairy whipped topping) as the end product, the base mixture 100 can include a relatively low proportion of salt 120—above a minimum threshold—for increased protein gelation and thus increased firmness of the whipped cream. However, if the base mixture 100 designates ice cream as the end product, the base mixture 100 can include a higher proportion of salt 120—below a maximum threshold—to achieve a creamier texture similar to a traditional dairy ice cream product.

In one implementation, the proportion of salt 120 dissolved in the volume of water 110 can be adjusted based on the isoelectric point of proteins in the proportion of proteins included in the base mixture 100. For example, a first batch (or “volume”) of the base mixture 100 can include: a first proportion of salt 120 dissolved in the volume of water 110; and a proportion of proteins defining a first isoelectric point. In this example, a second batch of the base mixture 100 can include: a second proportion of salt 120, less than the first proportion of salt 120, dissolved in the volume of water 110; and a proportion of proteins defining a second isoelectric point greater than the first isoelectric point.

Further, the base mixture 100 can include varying proportions of salt to adjust freezing point temperatures and/or regulate freezing point depressions of end products. For example, for a base mixture 100 designating ice cream as an end product, a subvolume of the base mixture 100 can include a first proportion of salt 120 and exhibit a first freezing point. This first subvolume of the base mixture 100 may be packed in pint-size containers and stored in freezers at grocery stores. A second subvolume of the base mixture 100 can include a second proportion of salt greater than the first proportion of salt 120 and exhibit a second freezing point less than the first freezing point. This second subvolume of the base mixture 100 may be stored in display freezers at ice cream shops, these display freezers maintained at lower temperatures than typical freezers at grocery stores. Thus, by including a higher salt content, the base mixture 100 exhibits freezing point depression and can be stored at lower temperatures while maintaining similar consistency (e.g., for ease of serving or scooping ice cream).

6.2 Calcium

The base mixture 100 can include a first proportion of calcium 130. Calcium is added to the aqueous salt-water mixture in preparation for addition of the protein-starch blend. Different forms of calcium can be added to the salt-water mixture dependent on the specified end product. The base mixture 100 can include different forms of calcium such as: calcium citrate, calcium lactate gluconate, calcium anhydrous chloride, calcium sulfate, tri-calcium phosphate, etc.

The base mixture 100 can include different forms and different concentrations of calcium to regulate protein gelation and/or rigidity of the base mixture 100. As calcium acts as a binder between the aqueous phase 102 and the oil phase 104 in the emulsion, the base mixture 100 can include different concentrations and types of calcium in the mixture to adjust a degree and duration of binding between water and oil droplets 172 in the base mixture 100.

For example, a first subvolume of the base mixture 100 may designate a soft cheese as the end product. The first subvolume can include a first proportion of calcium 130. A second subvolume of the base mixture 100 may designate a hard cheese as the end product. The second subvolume can include a second proportion of calcium greater than the first proportion of calcium 130, the second proportion of calcium configured to promote binding between the aqueous phase 102 and the oil phase 104 of the base mixture 100 throughout an extended aging process of the hard cheese. Thus, by including a greater proportion of calcium 130, the second subvolume of the base mixture 100 exhibits stronger binding between the aqueous phase 102 and the oil phase 104 over an extended duration when compared to the first subvolume of the base mixture 100.

Additionally, the base mixture 100 can include different forms and concentrations of calcium to regulate overrun in the end product.

6.3 Protein

The base mixture 100 includes a first proportion of proteins 140. Proteins in the base mixture 100 act as an emulsifier between the aqueous phase 102 and the oil phase 104 of the base mixture 100. Proteins include both hydrophobic heads and hydrophilic tails, which in combination enable the proteins to bind the aqueous phase 102 and the oil phase 104 to form the emulsion.

Generally, the base mixture 100 includes the proportion of proteins 140 including plant-extracted proteins and excluding dairy proteins (i.e., proteins derived from dairy milk)—such as casein protein and/or whey protein—such that the resulting base mixture 100 is non-dairy (i.e., excludes dairy ingredients). Further, the base mixture 100 can be mixed to include the proportion of proteins 140 including a particular blend of proteins—extracted and/or processed according to a particular method (e.g., matched to the target end product)—and at a particular concentration such that the resulting base mixture 100 exhibits a target functionality, flavor, color, and/or texture.

The base mixture 100 can include the first proportion of protein 140 proportional to a proportion of fats included in the oil phase 104, such that proteins fully emulsify oil droplets 172 in the base mixture 100. Additionally, the base mixture 100 can include the first proportion of protein 140s proportional to the first proportion (or “volume”) of water such that proteins are fully hydrated by water in the aqueous phase 102. Protein concentration can be modified relative to concentration of other ingredients in the base mixture 100 in order to regulate an extent of protein gelation, which affects structure of the base mixture 100 and end product. For example, a base mixture 100 can specify whipped cream as an end product. This base mixture 100 can include the first proportion of protein 140s configured to exhibit a greater extent of protein gelation, such that the first proportion of protein 140s exhibit high overrun and thus hold (or trap) air pockets in the base mixture 100. Thus, the base mixture 100 can be configured to include proteins that hold air in the base mixture 100, as opposed to traditional dairy products which include fats that hold air.

The base mixture 100 can include varying concentrations of protein to modify protein concentration based on the final product. In one implementation, the base mixture 100 includes a first proportion of protein 140s defining between two percent and eight percent of the base mixture 100 by weight.

Additionally, traditional dairy products typically specify a particular protein content. The base mixture 100 can be configured to reproduce this particular protein content in the base mixture 100 and thus in non-dairy (or “dairy-free”) end products, in order to achieve similar protein contents as dairy counterparts.

6.3.1 Protein Source

The proportion of proteins can be configured such that the resulting base mixture 100—configured to form a consumable, non-dairy product—exhibits a target functionality, flavor, color, and/or texture matched to a dairy product (e.g., milk, whipping cream, ice cream, spreadable cheese, yogurt, hard cheese) corresponding to the consumable, non-dairy product formed by the base mixture 100. Therefore, the proportion of proteins can include highly-functional proteins exhibiting characteristics of an emulsifier and/or a surfactant molecule, thereby enabling formation of the oil-in-water emulsion and/or micelle formation within this emulsion. Further, the proportion of proteins can be prepared (e.g., prior to mixing into the base mixture 100) via a purification process configured to improve protein functionality, flavor, color, and/or texture of the resulting base mixture 100.

In particular, the proportion of proteins 140 (e.g., plant-extracted proteins) can be configured to exhibit a target functionality configured to regulate foaming, gelling, and/or micelle formation within the base mixture 100. Additionally and/or alternatively, the proportion of proteins 140 can be configured to impart minimal color into the resulting base mixture 100. For example, a protein filtration process—implemented prior to adding the proportion of proteins 140 to the base mixture—can include a set of filters configured to reduce (or “lighten”) yellowness exhibited by the proportion of proteins 140. Additionally and/or alternatively, the proportion of proteins 140 can be configured to impart reduced “grassy” or “grain” flavors into the base mixture 100 (e.g., naturally and/or via the protein filtration process).

In one implementation, the proportion of proteins 140 can be configured to: exhibit a particular volatile profile—such as defining an amount of “grassy”, “grainy”, and/or “buttery” volatiles—corresponding to a target flavor profile of the resulting base mixture 100; exhibit a particular functionality profile—such as defining a set of binding, gelling, and/or foaming properties of proteins—corresponding to a target texture profile, a target flavor profile, and/or a target functionality of the resulting base mixture 100; and/or exhibit a particular pigment profile—such as a concentration or intensity of color—corresponding to a target color profile and/or target appearance of the resulting base mixture 100. In this implementation, the base mixture 100 can define a target texture profile, target flavor profile, target functionality, target color profile and/or target appearance based on the target (or “desired”) consumable non-dairy product.

For example, a first volume of the base mixture 100 can be configured to form a consumable non-dairy whipped topping configured to exhibit a first profile (e.g., corresponding to traditional dairy whipped cream) defining: a first target flavor profile; and a first target texture profile. In this example, the first volume of the base mixture 100 can include a first proportion of proteins 140 configured to exhibit: a first volatile profile—defining a first concentration of a target volatile (e.g., a “grain” volatile, a “butter” volatile)—corresponding to the first target profile; and a first functionality profile—defining a first set of binding properties, a first set of gelling properties, and a first set of foaming properties—corresponding to the first target texture profile.

Further, in this example, a second volume of the base mixture 100 can be configured to form a non-dairy frozen dessert configured to exhibit a second profile (e.g., corresponding to traditional dairy ice cream) including: a second target flavor profile; and a second target texture profile. The second proportion of proteins 140 can be configured to exhibit: a second volatile profile—defining a second concentration of the target volatile (e.g., exceeding the first concentration)—corresponding to the second target profile; and a second functionality profile—defining a second set of binding properties, a second set of gelling properties, and a second set of foaming properties—corresponding to the second target texture profile.

Therefore, these properties (e.g., volatile profile, functionality profile, pigment profile) of the proportion of proteins 140 can be controlled and/or regulated—such as before and/or after adding the proportion of proteins 140 to the base mixture 100—in order to generate a base mixture 100 that exhibits a particular flavor, texture, color, and/or functionality profile.

In one implementation, the base mixture 100 can include a proportion of plant-extracted proteins including proteins extracted from rapeseed. In particular, the base mixture 100 can include a proportion of low-erucic acid rapeseed proteins (or “Canola proteins”) extracted from low-erucic acid rapeseed oil (or “Canola oil”).

In one example, the base mixture 100 can include a proportion of Napin proteins extracted from Canola oil. In particular, the proportion of Napin proteins can be extracted from Canola oil via a filtration process (e.g., ultra-micron filtration) configured to isolate Napin proteins from Cruciferin proteins present in Canola oil and/or Canola meal (e.g., generated during cold expeller pressing of Canola oil). Additionally and/or alternatively, in another example, the base mixture 100 can include a proportion of Canola proteins including a proportion of Napin proteins and/or a proportion of Cruciferin proteins.

The proportion of Canola proteins (i.e., low-erucic acid rapeseed proteins) can be configured to exhibit high-functionality—such as exhibited by an extent of binding, foaming, gelling, and/or shear strength—once extracted from Canola oil. Additionally and/or alternatively, the proportion of Canola proteins can be extracted (e.g., purified) according to a particular extraction process configured to increase propensity of these Canola proteins to form micelles in the base mixture 100.

For example, during the extraction process, a base (e.g., a highly basic substance) can be added to the Canola proteins in order to flake out long-chain fatty acids that may form hydrophobic polymers. Later, when the proportion of Canola proteins are added to the base mixture 100, these hydrophobic polymers can be configured to form micelles in the base mixture 100. Additionally and/or alternatively, in another example, during the extraction process, an amount (e.g., percentage) of canola oil residual in extracted Canola proteins (e.g., Canola protein meal) can be regulated within a target range (e.g., between 5 percent and 10 percent). In this example, by maintaining the amount of Canola oil residual above a threshold amount (e.g., 1 percent, 5 percent, 10 percent), functionality of the proportion of Canola proteins as a surfactant can be improved or increased.

Additionally and/or alternatively, the proportion of canola proteins 140 can be configured to impart reduced “grassy” or “grain” flavors into the base mixture 100. For example, Canola protein meal can be generated via cold expeller pressing of Canola oil. The resulting Canola protein meal can be dried for a threshold duration (e.g., 12 hours, 24 hours, 36 hours) prior to filtration (e.g., ultra-micron filtration) of the Canola protein meal in order to enable reduction of grain volatiles (e.g., fresh grain volatiles) present in the Canola protein meal.

Alternatively, in another implementation, the base mixture 100 can include a proportion of plant-extracted proteins including proteins extracted from other plants in the Brassicaceae (or “Cruciferae”) family. In one example, the base mixture 100 can include a proportion of plant-extracted proteins including Brassica proteins, such as broccoli proteins and/or cabbage proteins.

In another implementation, the base mixture 100 can include a proportion of potato proteins, such as proteins extracted from peels of potatoes. For example, the base mixture 100 can include a low pH stable potato protein extracted from potato peels via protein precipitation at relatively low pH levels (e.g., pH less than 4). Additionally and/or alternatively, in another example, the base mixture 100 can include a neutral pH stable protein. In one example, the base mixture 100 includes a first proportion of a particular potato protein extracted from peels of potatoes grown in the Netherlands.

In yet another implementation, the base mixture 100 can include a proportion of plant-extracted proteins including: a first proportion of low-erucic rapeseed proteins (e.g., Canola proteins); and a second proportion of potato proteins.

However, the base mixture 100 can include a proportion of plant-extracted proteins—omitting dairy proteins (e.g., casein protein, whey protein)—derived from any plant type. For example, the proportion of plant-extracted proteins can include canola proteins, rice proteins, potato proteins, chickpea proteins, etc.

6.3.2 Protein Blend

In one variation, the proportion of proteins can include plant-extracted proteins of multiple protein types.

In particular, in this variation, the proportion of proteins can include plant-extracted proteins of a set of protein types and mixed at a particular protein ratio configured to yield a target functionality, a target flavor profile, and/or a target mouth-feel (or “texture”) for a particular non-dairy product formed of the base mixture 100.

For example, the base mixture 100 can include a proportion of plant-extracted proteins including a first proportion of proteins of a first protein type and a second proportion of proteins of a second protein type. The first proportion of proteins of the first type and the second proportion of proteins of the second type can be mixed at a target ratio corresponding to a target functionality and a target flavor profile defined for a consumable, non-dairy product (e.g., non-dairy milk, non-dairy frozen yogurt, non-dairy whipped cream, non-dairy ice cream) corresponding to a target dairy product (e.g., milk, frozen yogurt, whipped cream, ice cream). In this example, the proportion of plant-extracted proteins can further include proportions of proteins of additional protein types. For example, the proportion of plant-extracted proteins can include: a third proportion of proteins of a third protein type; a fourth proportion of proteins of a fourth protein type; a fifth proportion of proteins of a fifth protein type; etc. Each proportion of proteins, in the proportion of plant-extracted proteins, can be mixed at a particular ratio and configured to cooperate to achieve the target functionality, the target flavor profile, and/or the target mouth-feel defined for the consumable, non-dairy product.

In one implementation, the base mixture 100 can include a proportion of plant-extracted proteins including a mixture of canola proteins and proteins of a different protein type. In one example, the base mixture 100 can include a proportion of plant-extracted proteins including a first proportion of canola proteins and a second proportion of rice proteins. In another example, the base mixture 100 can include a proportion of plant-extracted proteins including a first proportion of canola proteins and a second proportion of chickpea proteins. In yet another example, the base mixture 100 can include a proportion of plant-extracted proteins including a first proportion of canola proteins and a second proportion of potato proteins.

In particular, in this implementation, the base mixture 100 can include a proportion of plant-extracted proteins: including a first proportion of canola proteins and a second proportion of secondary proteins; and defining a target ratio—corresponding to a target functionality and a target flavor profile—of the first proportion of canola proteins to the second proportion of secondary proteins. The first proportion of canola proteins and the second proportion of secondary proteins can therefore be mixed at different ratios in order to adjust functionality and flavor of the base mixture 100 and/or resulting non-dairy product (e.g., formed of the base mixture 100).

For example, a first batch of the base mixture can include a proportion of plant-extracted proteins defining a first ratio (e.g., between 1 and 2) of the first proportion of canola proteins to the second proportion of secondary proteins. A second batch of the base mixture can include a proportion of plant-extracted proteins defining a second ratio (e.g., between 0 and 1)—less than the first ratio—of the first proportion of canola proteins to the second proportion of secondary proteins, such that the second batch of the base mixture 100 includes a smaller proportion of canola proteins than the first batch. In this example, the first batch of the base mixture 100 can be configured to form a non-dairy milk product defining a first target functionality—such as characterized by a first set of binding properties, a first set of gelling properties, and/or a first set of foaming properties— and a first target flavor profile corresponding to the first target ratio and configured to mimic a functionality and flavor profile of a traditional dairy milk.

In particular, in the preceding example, the first batch of the base mixture 100— including the proportion of plant-extracted proteins defining the first ratio of canola proteins to secondary proteins—can be configured to exhibit a relatively mild flavor profile and a relatively high degree of functionality, such that the resulting non-dairy milk product tastes and behaves similarly to dairy milk in different applications. For example, the non-dairy milk product—including the proportion of plant-extracted proteins defining the first ratio of canola proteins to secondary proteins—can be configured to foam when frothed (e.g., via a milk frother) and/or to blend into hot beverages (e.g., coffee, tea) without curdling. The second batch of the base mixture 100 can be configured to form a non-dairy cheese product defining a second target functionality—such as characterized by a second set of binding properties, a second set of gelling properties, and/or a second set of foaming properties—and a second target flavor profile corresponding to the second target ratio and configured to mimic a functionality and flavor profile of a traditional dairy cheese. In particular, the second batch of the base mixture 100—including the proportion of plant-extracted proteins defining the second ratio of canola proteins to secondary proteins—can be configured to exhibit a relatively strong flavor profile and a relatively low degree of functionality (e.g., compared to the non-dairy milk product), such that the resulting non-dairy cheese product tastes and behaves similarly to dairy cheese.

Additionally and/or alternatively, in the preceding implementation, the proportion of plant-extracted proteins can define a target ratio of the first proportion of canola proteins to the second proportion of secondary proteins corresponding to a set of target characteristics—such as defined for a particular non-dairy product or products—including a target functionality, a target flavor profile, a target texture or “mouth-feel”, a target appearance, and/or a target shelf life. In particular, the proportion of canola proteins and the proportion of secondary proteins (e.g., chickpea proteins, rice proteins, potato proteins) can be mixed at a particular ratio to regulate a functionality, a flavor profile, a mouth feel, an appearance, and/or shelf life of the base mixture 100 and/or the resulting non-dairy product derived from the base mixture 100.

In one example, the base mixture 100 can include a proportion of plant-extracted proteins including a first proportion of canola proteins and a second proportion of secondary proteins mixed at a ratio of 60:40 (e.g., sixty percent canola proteins and forty percent secondary proteins). In this example, the base mixture 100 can be configured to form a non-dairy milk product exhibiting functionality—such as foaming, whipping, gelling, thickening, blending, etc. —flavor, mouth-feel, appearance, and shelf life mimicking those of a dairy milk.

Additionally and/or alternatively, in another implementation, the base mixture 100 can include a proportion of plant-extracted proteins including a mixture of chickpea proteins and secondary proteins of a different protein type. In one example, the base mixture 100 can include a proportion of plant-extracted proteins including a first proportion of chickpea proteins and a second proportion of pea proteins. In another example, the base mixture can include a proportion of plant-extracted proteins including a first proportion of chickpea proteins and a second proportion of rice proteins. Further, in this implementation, the proportion of plant-extracted proteins can similarly define a target ratio of the first proportion of chickpea proteins to the second proportion of secondary proteins corresponding to a set of target characteristics (e.g., defined for a particular non-dairy product or products), such as a target functionality, a target flavor profile, a target texture or “mouth-feel”, a target appearance, and/or a target shelf life. In particular, the proportion of chickpea proteins and the proportion of secondary proteins (e.g., rice proteins, pea proteins, potato proteins) can be mixed at a particular ratio to regulate a functionality, a flavor profile, a mouth feel, an appearance, and/or shelf life of the base mixture 100 and/or the resulting non-dairy product derived from the base mixture 100.

6.3.2.1 Secondary Protein Selection

Additionally, in this variation, the proportion of secondary proteins can be selected based on compatibility with the proportion of canola proteins. In particular, the proportion of secondary proteins can be configured to exhibit characteristics—such as electrical charge (e.g., positive, neutral, negative), size, functionality, stability, solubility, etc. —that enable combination of the proportion of secondary proteins with the proportion of canola proteins and generation of the base mixture 100 exhibiting the set of target characteristics.

In particular, in one implementation, the proportion of secondary proteins can include neutral, bulking proteins—exhibiting relatively low functionality — configured to exhibit relatively high compatibility with negatively-charged and highly functional canola proteins. Additionally and/or alternatively, in another implementation, the proportion of secondary proteins can include proteins defining a particular flavor profile configured to regulate the target flavor profile of the base mixture 100. In this implementation, the proportion of canola proteins can define a functionality configured to regulate the target functionality of the base mixture 100. The proportion of secondary proteins can then be mixed with the proportion of canola proteins to drive the flavor profile of the base mixture 100 toward the target flavor profile.

Additionally and/or alternatively, in yet another implementation, the proportion of secondary proteins can be configured to regulate a mouth-feel or texture of the base mixture 100. In this implementation, the proportion of secondary proteins can be mixed with the proportion of canola proteins to drive a mouth-feel of the base mixture 100 toward the target mouth-feel defined for the base mixture 100 and/or resulting non-dairy product.

Additionally and/or alternatively, in this variation, the proportion of plant-extracted proteins can include a proportion of secondary proteins selected based on compatibility with a proportion of primary proteins of any protein type (e.g., canola, rice, chickpea, pea, potato). For example, the proportion of secondary proteins can be configured to exhibit characteristics—such as electrical charge, size, functionality, stability, solubility, etc. —that enable combination of the proportion of secondary proteins with the proportion of primary proteins and generation of the base mixture 100 exhibiting the set of target characteristics.

6.3.3 Variation: Protein Stabilizers

In one variation, the base mixture 100 can include a proportion of protein stabilizers (hereinafter “stabilizing agents”) configured to stabilize proteins, in the proportion of plant-extracted proteins, within the base mixture 100. For example, the base mixture 100 can include a proportion of stabilizing agents—such as pectin, gellan gum, a hydrocolloid blend, etc. —configured to stabilize canola proteins, in the proportion of plant-extracted proteins, to prevent phase separation (e.g., during processing, throughout a shelf-life of the base mixture 100) and/or loss of protein functionality.

In one implementation, the base mixture 100 can include a proportion of stabilizing agents configured to stabilize plant-extracted proteins, in the proportion of plant-extracted proteins, during pasteurization of the base mixture 100. In particular, the proportion of stabilizing agents can be configured to cooperate with proteins, in the proportion of plant-extracted proteins, to stabilize proteins at relatively high temperature—such as within a threshold deviation of and/or exceeding an isoelectric point of these proteins—during high-temperature pasteurization (e.g., high-temperature-short-time or “HTST” pasteurization, ultra-high-temperature or “UHT” pasteurization) of the base mixture 100. For example, the base mixture 100 can include a proportion of plant-extracted proteins including canola proteins. In this example, the base mixture 100 can further include a proportion of stabilizer—such as a proportion of a pectin or another thickening or gelling agent—configured to prevent separation of canola proteins from fat globules in the emulsion (i.e., the base mixture) and thus stabilize the emulsion (i.e., the base mixture) during ultra-high-temperature (or “UHT”) pasteurization at high temperatures, such as at temperatures between 280-degrees Fahrenheit and 294-degrees Fahrenheit.

Additionally, in another implementation, the base mixture 100 can include a proportion of stabilizing agents configured to cooperate with the proportion of plant-extracted proteins to preserve functionality of these proteins and therefore of the base mixture 100 and/or the resulting non-dairy product. For example, the base mixture 100 can include a proportion of plant-extracted proteins including canola proteins. In this example, the base mixture 100 can be configured to form a non-dairy milk or cream configured for mixing in hot beverages (e.g., coffee, tea). Therefore, the base mixture 100 can further include a proportion of a first set of stabilizing agents (e.g., phosphates, acacia gum, gellan gum, pectin) configured to interact with canola proteins, in the proportion of plant-extracted proteins, to prevent separation of canola proteins from fat globules in the base mixture 100 at high temperatures, and therefore prevent curdling of the resulting non-dairy milk (i.e., the base mixture 100) when mixed with hot beverages. In a similar example, the base mixture 100 can be configured to form a non-dairy milk (e.g., a non-dairy whole milk) configured for implementing as a baking ingredient in baked goods. In this example, the base mixture 100 can include: a proportion of plant-extracted proteins including canola proteins; and a proportion of a second set of stabilizing agents (e.g., phosphates, acacia gum, gellan gum, pectin) configured to interact with canola proteins in the base mixture 100 to stabilize canola proteins throughout a baking process—such as including mixing with other ingredients and/or baking at high temperatures—and within a final baked good including the non-dairy milk.

In yet another example, the base mixture 100 can be configured to form a soft-serve ice cream configured for consumption within a target shelf life of 24 months. In this example, the base mixture 100 can include: a proportion of plant-extracted proteins including canola proteins; and a proportion of a third set of stabilizing agents (e.g., guar gum, acacia gum, locust bean gum) configured to interact with canola proteins in the base mixture 100 to stabilize these canola proteins throughout a duration of the target shelf and thus maintain a target flavor profile, target mouth-feel, and/or target appearance and structure—such as including a dispersion of stabilized air bubbles—of the non-dairy soft-serve ice cream.

Additionally, in another implementation, the base mixture 100 can include a proportion of stabilizing agents configured to cooperate with the proportion of plant-extracted proteins to stabilize these proteins in the base mixture 100 over a target shelf life of the base mixture 100 and/or the resulting non-dairy product derived from the base mixture 100. In particular, in this implementation, the base mixture 100 can include a proportion of a set of stabilizing agents (e.g., gellan gum) configured to stabilize plant-extracted proteins (e.g., canola proteins) present in the base mixture 100—such as by preventing phase separation within the base mixture 100—within a target temperature range (e.g., less than 45 degrees Fahrenheit, room temperature) over a target shelf life of the base mixture 100. For example, the base mixture 100 can include a proportion of hydrocolloid (e.g., gellan gum)—or a blend of hydrocolloids (e.g., gellan gum, Arabic gum, tara gum, guar gum) configured to stabilize the proportion of plant-extracted proteins in suspension, and thereby prevent or limit phase separation within the base mixture 100 over a target shelf life (e.g., 1 month, 6 months, 1 year, 2 years).

Additionally, in yet another implementation, the base mixture 100 can include a proportion of stabilizing agents—including a blend of stabilizing agents—configured to cooperate to stabilize the proportion of plant-extracted proteins during initial processing (e.g., HTST pasteurization, UHT pasteurization) and over the target shelf life and thus cooperate with the proportion of plant-extracted proteins to maintain the target functionality of the resulting base mixture 100 and/or non-dairy product during processing and over the target shelf life. For example, the base mixture 100 can include a proportion of stabilizing agents including: a first proportion of a first stabilizing agent configured to stabilize the proportion of plant-extracted proteins during high-temperature pasteurization (e.g., HTST pasteurization, UHT pasteurization); a second proportion of a second stabilizing agent configured to stabilize the proportion of plant-extracted proteins within the target temperature range over the target shelf; and a third proportion of a third stabilizing agent configured to stabilize the proportion of plant-extracted proteins during application of the resulting base mixture 100—such as when poured in coffee or when included in a baked good—to preserve functionality of the base mixture 100.

Additionally, in one variation, the base mixture 100 can include a proportion of stabilizing agents corresponding to an amount of solids present in the base mixture 100. In particular, in this implementation, the base mixture 100 can include a proportion of stabilizing agents corresponding to (e.g., proportional) a ratio of the proportion of plant-extracted proteins to a proportion of solids (e.g., solid ingredients) in the base mixture 100.

6.4 Starch

The base mixture 100 includes a first proportion of starch 150. The base mixture 100 includes the first proportion of starch 150 configured to stabilize the aqueous phase 102 of the base mixture 100 when mixing in additional ingredients and more specifically when emulsifying the oil into the base mixture 100. The starch stabilizes the aqueous phase 102 by promoting the homogeneous suspension of proteins and starches in the base mixture 100. By including starches configured to maintain this homogeneous suspension, the base mixture 100 can limit any phase separation, such that non-dairy end products exhibit smooth textures and consistencies similar to dairy counterparts.

The base mixture 100 can include different concentrations of starches to modify viscosity of the aqueous mixture. For example, the base mixture 100 can include a higher concentration of starch in the base mixture 100 configured to make ice cream, while the base mixture 100 can include a lower concentration of starch in the base mixture 100 configured to make yogurt. Thus, by including varying concentrations of starch, the base mixture 100 can exhibit different consistencies in the end product.

The base mixture 100 can include starches in various forms including: potato starch; cornstarch; cassava starch; waxy maize starch; tapioca maltodextrin; etc. The base mixture 100 can include a proportion of potato starch including starches extracted from peels of potatoes. The base mixture 100 can include starches and proteins extracted from the same type of potato. In one implementation, the base mixture 100 includes the first proportion of starch 150 including: a first quantity of potato starch; a first quantity of cornstarch; and a first quantity of cassava starch. In another implementation, the base mixture 100 includes the first proportion of starch 150 including: a first quantity of potato starch; a first quantity of cornstarch; a first quantity of cassava starch; a first quantity of waxy maize starch; and a first quantity of tapioca maltodextrin. In another implementation, the base mixture 100 includes the first proportion of starches 150 including: a first quantity of potato starch; a second quantity of waxy maize starch; and a third quantity of Tapioca Maltodextrin.

6.5 Sweetener

The base mixture 100 includes a first proportion of sweetener 160. In addition to sugar, the base mixture 100 can include a first proportion of sweetener 160 such as: sugar, glucose, dextrose, maltose, corn syrup, tapioca syrup, brown rice syrup, etc. In one implementation, the base mixture 100 includes a first proportion of sweetener 160 including a first quantity of sugar and a first quantity of glucose.

The base mixture 100 can include varying concentrations of sweeteners configured to modify the taste and texture of the end product. The base mixture 100 includes sweeteners (e.g., sugar, glucose) and other solids in the aqueous phase 102 of the base mixture 100. Inclusion of additional solids in the base mixture 100 increases stability and firmness of the aqueous solution. Thus, by including increased sweetener concentration in the base mixture 100, the base mixture 100 can exhibit greater stability and better consistency.

Additionally, the base mixture 100 exhibits greater freeze point depression with higher concentrations of sweetener. In particular, the base mixture 100 can include higher concentrations of particular sweeteners (e.g., sucrose) in order to lower the freeze point of an end product. For example, a first subvolume of the base mixture 100 can include a first proportion of sweetener 160s including a first quantity of glucose and a first quantity sucrose, the first subvolume of the base mixture 100 exhibiting a first freeze point of 28 degrees Fahrenheit. A second subvolume of the base mixture 100 can include a second proportion of sweeteners—the second proportion greater than the first proportion—including the first quantity of glucose and a second quantity of sucrose greater than the first quantity of sucrose, the second subvolume of the base mixture 100 exhibiting a second freeze point of 26 degrees Fahrenheit.

6.6 Fat

The base mixture 100 includes a first proportion of fat (e.g., canola oil, sunflower oil, and/or safflower oil). The first proportion of fat may be the final ingredient added to the base mixture 100. Once the base mixture 100 reaches or exceeds a threshold temperature for emulsification, the oil may be added at a substantially consistent rate in order to generate uniform dispersion of approximately uniform oil droplets 172 (e.g., uniform shape, uniform size). The base mixture 100 includes a particular ratio of water to oil such to hydrate starches and sugars which compete for the same water content. Additionally and/or alternatively, the non-dairy base mixture 100 can include a proportion of fat corresponding to a standard proportion of fat present in a corresponding dairy product. For example, the base mixture 100 can be configured to form a non-dairy whole milk product and can include a proportion of fat (e.g., canola oil) such that the resulting non-dairy whole milk product includes approximately 4.30 percent fat (e.g., within 0.50 percent). In another example, the base mixture 100 can be configured to form a non-dairy 2% milk product and can include a proportion of fat such that the resulting non-dairy whole milk product includes approximately 2 percent fat (e.g., within 0.10 percent). In yet another example, the base mixture 100 can be configured to form a non-dairy frozen dessert product (e.g., a non-dairy ice cream product) and can include a proportion of fat such that the resulting non-dairy frozen dessert product includes between 16 percent fat and 18 percent fat.

The base mixture 100 can include the first proportion of fat in the form of different oils depending on the specified end product. Fats and oils with higher saturated fat content may emulsify the base mixture 100 more readily and with greater consistency than fats with lower saturated fat content or unsaturated fat content. For example, olive oil contains a low saturated fat content and therefore may exhibit poor function as an emulsifier. Conversely, canola oil contains a high proportion of saturated fat content and can therefore emulsify the mixture more quickly and consistently and can persist in dispersion with the aqueous phase 102 of the base mixture 100 over a longer duration of time than olive oil.

Additionally, the base mixture 100 can include both unsaturated fats and saturated fats. For example, the base mixture 100 can include canola oil with high unsaturated fat content and low saturated fat content for the base mixture 100 configured to make ice cream. Alternatively, the base mixture 100 can include a rice bran oil with low unsaturated fat content and high saturated fat content for the base mixture 100 configured to make a hard cheese.

Additionally, the base mixture 100 can include additional fats configured to cooperate with unsaturated fats to act as substitute saturated fats. The base mixture 100 can include: monoglycerides; diglycerides; lecithin; etc.

### 7. Processing the Base Mixture

Generally, the base mixture 100 can initially incorporate the same set of (e.g., seven) ingredients, such as including: water, salts, calcium (e.g., calcium derivatives), starches, proteins, sugars, and oil. However, concentrations of these base ingredients in the base mixture 100 may be set (i.e., adjusted) to yield different flavors, textures, stiffness, and/or states based on designated end products.

7.1 Preparing the Aqueous Phase

Block S110 of the method S100 recites treating a volume of water 110 with a first set of ingredients soluble in the volume of water 110, the volume of water 110 within a first temperature range. Generally, the first set of ingredients can be dissolved in the volume of water no to generate an aqueous solution.

In one implementation, the first set of ingredients includes the first proportion of salt 120 and the first proportion of calcium 130. In this implementation, the volume of water 110 can be treated with the first proportion of salt 120 and the first proportion of calcium 130 to prepare the aqueous phase 102 for addition of proteins and starches. Initially, the volume of water 110 can brought to or left at temperatures within a temperature range of approximately 40 degrees-F to 110 degrees-F (e.g., within ten percent), such that the first proportion of salt 120 and the first proportion of calcium 130 dissolve in the volume of water 110. The first proportion of salt 120 can be dissolved in the first proportion of water 110 to form an aqueous salt-water mixture. The first proportion of calcium 130 can then be added to the aqueous salt-water mixture to form a first (aqueous) mixture.

Block S120 of the method recites blending a second set of ingredients into the first mixture to generate a second mixture, the second set of ingredients including a protein-starch blend. The protein-starch blend can be mixed into the first mixture for a set duration (e.g., one minute, ten minutes, one hour) and at sufficient shear to achieve a homogeneous mixture of the protein-starch blend and the first mixture.

The protein-starch blend can be mixed prior to addition of this blend to the first mixture and can include a first proportion of protein 140s and a first proportion of starch 150es. In one implementation, the second set of ingredients includes: a first quantity of plant-extracted protein, a second quantity of potato starch, a third quantity of cornstarch, and a fourth quantity of cassava starch. These ingredients can be mixed separately from the first mixture to form the protein-starch blend.

The second set of ingredients can additionally include: a first proportion of tapioca maltodextrin; a first proportion of an oat hydrocolloid; a first proportion of a gum (e.g., locust bean, Arabic); and/or a first proportion of bioavailable trace minerals.

The protein-starch blend can be mixed into the first mixture for a set duration corresponding to a volume of the first mixture. For example, if the volume of the first mixture is relatively small (e.g., less than 10 gallons), the protein-starch blend can be mixed into the first mixture for a set duration of 5 minutes. However, if the volume of the first mixture is relatively large (e.g., greater than 500 gallons), then the protein-starch blend can be mixed into the first mixture for a set duration of 20 minutes. Thus, the protein-starch blend can be mixed into the first mixture for the set duration proportional to the volume of the first mixture, in order to achieve homogeneity of the second mixture including both the first and second set of ingredients. The second mixture is then set to hydrate with no sheer for a set duration between 20 seconds and 30 minutes.

In one implementation, the protein-starch blend is mixed into the aqueous solution via a high-shear impeller. For example, the protein-starch blend can be mixed into the aqueous solution via a high shear bottom impeller operating between 1800 revolutions per minute and 2100 revolutions per minute for a set duration of 5 minutes.

Additionally and/or alternatively, in another implementation, the protein-starch blend and/or proportion of proteins can be mixed into the base mixture 100 via a high-shear impeller operating at a shear within a target shear range (e.g., between 120 RPM and 1000 RPM) corresponding to a protein type (e.g., Canola, potato, cabbage) of proteins in the proportion of proteins. For example, if the proportion of proteins includes a highly-functional protein, the proportion of proteins can be mixed into the base mixture 100 at a first target shear (e.g., 150 RPM) configured to reduce foaming of the base mixture 100 due to the highly-functional protein. However, if the proportion of proteins includes a less-functional protein, the proportion of proteins can be mixed into the base mixture 100 at a second target shear (e.g., 100 RPM) less than the first target shear to conserve energy. Therefore, in order to cavitate foaming in the base mixture 100 when mixing in the proportion of proteins, the base mixture 100 can be mixed at a target shear proportional a functionality of these proteins, exhibited by an extent of foaming of the base mixture 100.

In one variation, the second set of ingredients further includes sweeteners. For example, the second set of ingredients including proteins, starches, and sweeteners (e.g., sugar, glucose) can be mixed into the first solution to form the second solution. Sweeteners can be included in the second set of ingredients to promote dispersion of dry ingredients (e.g., starches) in the second mixture. Alternatively, sweeteners can be added following a hydration process in which proteins and starches absorb water from the aqueous solution.

Following addition of the second set of ingredients, the second solution can be left to hydrate for a set duration (e.g., 1 minute, 5 minutes, 30 minutes) with no shear to enable hydration of the second set of ingredients (e.g., proteins, starches) in the second mixture.

Block S130 of the method S100 recites adding a third set of ingredients to the second mixture in a standard sequence to form a third mixture. The third set of ingredients can include sweeteners, such as: sugar; glucose; sucrose; maltose; corn syrup, tapioca syrup; flavorings (e.g., cocoa powder); etc. In one implementation, the third set of ingredients includes sugar, glucose, and sucrose. The proportions of each of these sweeteners may be adjusted depending on the desired end product.

In one implementation, the second and/or third mixture can be mixed (e.g., prior to pasteurization) to include a particular ratio of solids to liquid in the mixture. In particular, this mixture can be configured to exhibit a particular ratio of solids to liquids, such that the mixture exhibits a target viscosity in preparation for pasteurization of the mixture (e.g., the second and/or third mixture). By regulating viscosity of this mixture within a threshold deviation of the target viscosity, foaming of the base mixture 100 during pasteurization can be controlled. For example, during pasteurization, a first mixture exhibiting a first viscosity can exhibit a first extent of foaming. In this example, during pasteurization, a second mixture exhibiting a second viscosity, exceeding the first viscosity, can exhibit a second extent of foaming less than the first extent of foaming.

In one implementation, a first set of ingredients—including a volume of water, an amount (e.g., proportion, concentration, weight) of salt, and an amount of calcium—can be mixed to form a first mixture during a preparation period. Then, during the preparation period, a second set of ingredients—including an amount of starches, an amount of plant-extracted proteins, an amount of stabilizing agents configured to stabilize the amount of plant-extracted proteins, and/or an amount of sweeteners—can be mixed into the first mixture to form a second mixture. In particular, the amount of plant-extracted proteins can include a first amount of canola proteins and a second amount of secondary proteins (e.g., rice proteins, chickpea proteins) mixed at a protein ratio corresponding to a set of characteristics (e.g., defined for a particular non-dairy product), such as including a target functionality, a target flavor profile, a target “mouth-feel” or texture, and/or a target appearance (e.g., color).

Then, during a blending period succeeding the preparation period, the second mixture can be: held at temperatures within a first temperature range; and emulsified with a volume of oil. In particular, the volume of oil can be blended into the second mixture—at temperatures within the first temperature range—to form an emulsion including a dispersion of oil droplets within the volume of water. During a pasteurization period succeeding the blending period, the emulsion (i.e., the base mixture 100) can then be pasteurized—such as according to a particular pasteurization process—at temperatures within a second temperature range and for a first duration defined for the particular pasteurization process. Finally, during a homogenization period succeeding the pasteurization period, the emulsion (i.e., base mixture 100) can be homogenized at temperatures within a third temperature range and for a second duration to form the base mixture 100 configured to form a consumable, non-dairy product (e.g., non-dairy milk, non-dairy yogurt, non-dairy ice cream) exhibiting the target set of characteristics, such as including the target functionality, the target flavor profile, the target “mouth-feel” or texture, and/or the target appearance.

### 8. Pasteurization

Block S140 of the method recites pasteurizing the third mixture, within a set temperature range and for a set duration. The third mixture can be heated to temperatures within the first temperature range (e.g., 150 degrees-F to 200 degrees-F) and held in this second temperature range for a set duration (e.g., 20 minutes, 30 minutes, 1 hour) to pasteurize the third mixture. For example, the third mixture—defining a homogeneous suspension of salt, calcium, proteins, starches, and sugars in water—can be heated to a temperature of 160 degrees and held at this temperature for a duration of 30 minutes. The third mixture can be pasteurized to eliminate harmful bacteria and/or other contaminants present in the third mixture before undergoing further processing. In particular, the third mixture—defining a homogenous suspension of salt, calcium, proteins, starches, and/or sugars in water—can be pasteurized according to a particular pasteurization process.

8.1 High-Temperature-Short-Time Pasteurization

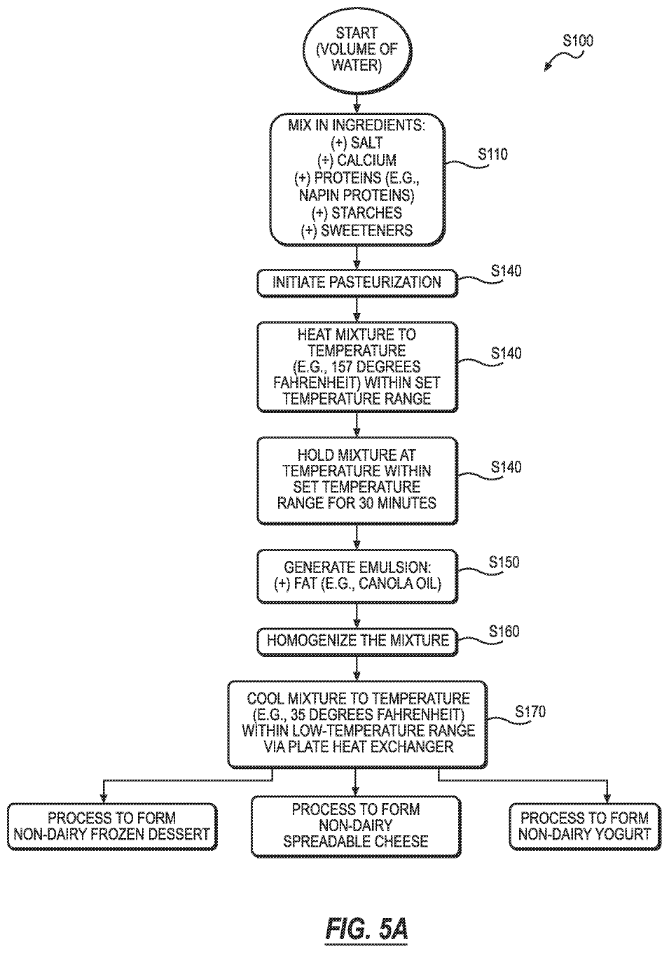

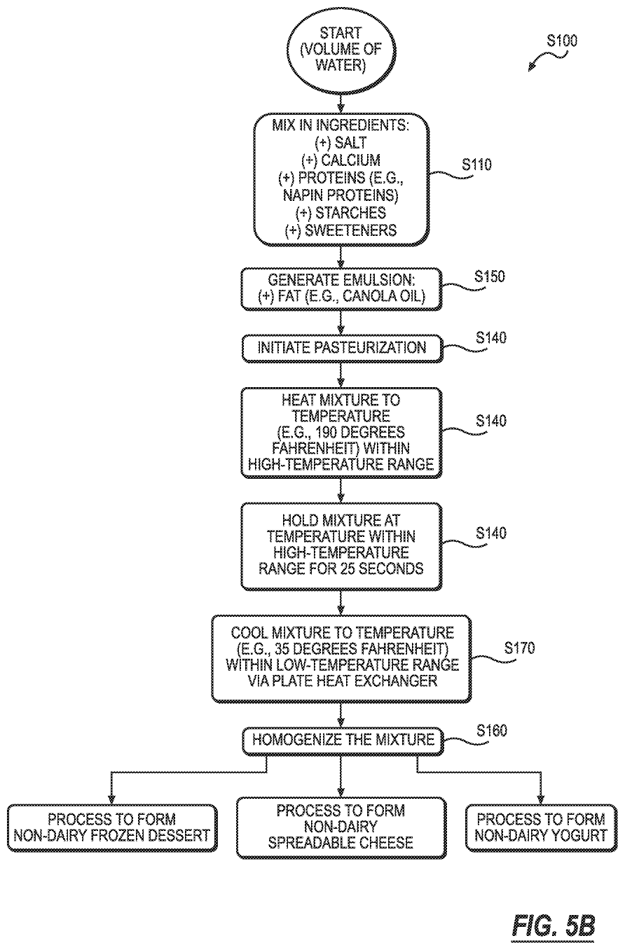

In one implementation, as shown in FIG. 5B, the third mixture can be pasteurized via an HTST (or “high-temperature short-time”) pasteurization process. In this implementation, the third mixture can be: heated to a temperature within a high-temperature range (e.g., between 165 degrees Fahrenheit and 200 degrees Fahrenheit); and held at this temperature for a defined pasteurization duration (e.g., 25 seconds, 45 seconds, 1 minute). Upon expiration of the pasteurization duration, the third mixture can be run through a plate heat exchanger (e.g., within a threshold duration) to cool the third mixture to a temperature within a target temperature range (e.g., between 25 degrees Fahrenheit and 40 degrees Fahrenheit).

For example, the third mixture can be held at approximately (e.g., within five percent) 190 degrees Fahrenheit for a pasteurization duration of 25 seconds. In this example, the third mixture can then be cooled to a temperature of approximately (e.g., within 5 percent) 35 degrees Fahrenheit via running of the third mixture through a plate heat exchanger—such as within 10-15 seconds of expiration of the pasteurization duration—prior to homogenization of the third mixture.

Additionally and/or alternatively, in this implementation, the proportion of fats (e.g., low-erucic rapeseed oil, sunflower oil, safflower oil) can be added to the mixture prior to pasteurization of the mixture. In particular, by pasteurizing the mixture at temperatures within a relatively high temperature range (e.g., between 165 degrees Fahrenheit and 200 degrees Fahrenheit) and therefore enabling pasteurization over a relatively short duration (e.g., less than 30 seconds, less than 25 seconds, less than 20 seconds), an extent (e.g., magnitude) of oxidation of unsaturated fats present in the proportion of fats can be reduced.

Additionally, in this implementation, the base mixture 100 can include the proportion of stabilizing agents configured to stabilize proteins, in the proportion of plant-extracted proteins, as described above. In particular, the proportion of stabilizing agents can be configured to stabilize proteins present in the base mixture 100 at relatively high temperatures during pasteurization. For example, the base mixture 100 can include a proportion of plant-extracted proteins including a proportion of canola proteins defining a denaturation temperature falling below and outside of a target temperature range defined for the HTST pasteurization process. Therefore, in this example, the base mixture 100 can include a proportion of stabilizing agents—such as including pectin or sodium caprylate—configured to prevent denaturation of the proportion of canola proteins during the HTST pasteurization process.

In one variation, the base mixture 100 can be processed via an extended shelf-life (or “ESL”) process. In particular, in this variation, the base mixture 100 can be: heated to temperatures within a high, ESL temperature range—such as between 260 degrees Fahrenheit and 280 degrees Fahrenheit—defined for the ESL process; and held at this temperature for a defined ESL duration falling below the defined pasteurization duration. For example, the base mixture 100 can be heated to a temperature of approximately 277 degrees Fahrenheit (e.g., within 1 percent, within 5 percent) and held at this temperature for an ESL duration between 2.5 seconds and 6 seconds. In this variation, the proportion of fats can similarly be added to the base mixture 100 prior to initiation of the ESL process. Further, the base mixture 100 can include a proportion of stabilizing agents configured to stabilize proteins (e.g., canola proteins) in the proportion of plant-extracted proteins at temperatures within the ESL temperature range in order to prevent denaturation—and/or protein coagulation—and preserve functionality of these proteins.

Additionally, in another variation, the base mixture 100 can be processed via aseptic processing. In particular, in this variation, the base mixture 100 can be: heated to temperatures within a high, aseptic temperature range (e.g., between 250 degrees Fahrenheit and 300 degrees Fahrenheit) exceeding temperature ranges defined for the ESL process and the HTST pasteurization process; and held at this temperature for a defined aseptic processing duration falling below the defined pasteurization duration. For example, the base mixture 100 can be heated to a temperature of approximately 285 degrees Fahrenheit (e.g., within 1 percent, within 5 percent) and held at this temperature for an aseptic processing duration between 2.5 seconds and 6 seconds. In this variation, the proportion of fats can similarly be added to the base mixture 100 prior to initiation of aseptic processing. Further, the base mixture 100 can include a proportion of stabilizing agents configured to stabilize proteins (e.g., canola proteins) in the proportion of plant-extracted proteins at temperatures within the aseptic temperature range, in order to prevent denaturation—and/or protein coagulation—and preserve functionality of these proteins.

8.2 Low-Temperature, High-Duration Pasteurization

Alternatively, in another implementation, as shown in FIG. 5A, the third mixture—including salt, calcium, proteins, starches, and/or sugars in water—can be pasteurized according to a slow pasteurization process (e.g., a lower-temperature, higher-duration pasteurization process). In particular, in this implementation, the third mixture can be pasteurized at temperatures within a lower temperature range (e.g., between 150 degrees Fahrenheit and 165 degrees Fahrenheit) and over a longer duration (e.g., exceeding 25 minutes). In one example, the third mixture can be held at approximately (e.g., within five percent) 156 degrees Fahrenheit for a duration of 30 minutes. In this implementation, the proportion of fats (e.g., oil) can be added to the mixture after pasteurization of the mixture in order to limit oxidation of unsaturated fats present in the proportion of fats.

8.3 Pasteurization Process Selection

The pasteurization process can be selected based on a type of processing (e.g., batch processing, semi-continuous processing) of the base mixture 100. In particular, in one example, volumes of the base mixture 100 can be processed via batch-processing. In this example, the base mixture 100 can be pasteurized according to the slow pasteurization process. Alternatively, in another example, volumes of the base mixture 100 can be processed via semi-continuous processing. In this example, the base mixture 100 can be pasteurized according to the HTST process.

Additionally and/or alternatively, the pasteurization process can be selected based on a target flavor of the resulting, non-dairy product (e.g., non-dairy milk, non-dairy whipped cream, non-dairy frozen dessert, non-dairy cheese). In particular, pasteurization at higher temperatures—such as according to the HTST pasteurization process—can reduce “grassy” flavors (e.g., via reduction of grassy volatiles in the mixture) in the mixture thereby amplifying “buttery” flavors and/or “buttery” volatiles in the mixture. Therefore, a volume of the base mixture 100 configured to form a non-dairy product exhibiting increased “buttery” flavors can be pasteurized according to the HTST pasteurization process. Alternatively, a volume of the base mixture 100 configured to form a non-dairy product exhibiting reduced “buttery” flavors and/or increased “grassy” flavors can be pasteurized according to the slow pasteurization process.

Additionally and/or alternatively, this third mixture—defining a homogeneous suspension of salt, calcium, proteins, starches, and/or sugars in water—can be heated to a temperature within a temperature range and over a set duration according to a particular pasteurization process defined by characteristics of proteins in the proportion of proteins.

For example, the third mixture can include a proportion of Canola proteins (e.g., Napin proteins). During pasteurization, in order to limit denaturation of Canola proteins in the proportion of Canola proteins, the third mixture can be heated to a temperature within a temperature range (e.g., between 155 degrees Fahrenheit and 195 degrees Fahrenheit) and held at this temperature for a set duration (e.g., between 20 seconds and 40 minutes) based on times and temperatures at which Canola proteins exhibit denaturation. In particular, in this example, the third mixture—including a proportion of Canola proteins—can be pasteurized via HTST (or “high temperature short time”), such as by heating the third mixture to approximately 190 degrees Fahrenheit (e.g., within 5 degrees) for approximately of 25 seconds (e.g., within 2 seconds). Alternatively, in this example, the third mixture—including a proportion of Canola proteins—can be pasteurized by heating the third mixture to a temperature between 155 degrees Fahrenheit and 158 degrees Fahrenheit for a minimum of 30 minutes. Therefore, a duration of pasteurization can be adjusted by inversely adjusting the temperature of the pasteurization process.

In one variation, following pasteurization, a fourth set of ingredients can be added to the third mixture to generate a fourth mixture. The fourth set of ingredients can include a first proportion of sodium bicarbonate and a first proportion of a basic amino acid (e.g., proline). The base mixture 100 can include this fourth set of ingredients to buffer a pH level of the base mixture 100, such that the pH level is increased and the base mixture 100 is less acidic. Additionally, the base mixture 100 can include this proportion of the basic amino acid to neutralize and/or counteract tannins present in proteins in the base mixture 100—in order to achieve a particular taste profile on the palate.

8.4 Emulsification

The base mixture 100 including these ingredients is then heated to a target temperature and emulsified with oil to reach a stable emulsion. The base mixture 100 can thus undergo a high shear coarse emulsion to achieve this stable emulsion exhibiting substantially uniform oil droplet size (e.g., diameter less than 10 microns). For example, a base mixture 100 configured to make a non-dairy milk end product may exhibit substantially uniform oil droplet size between 4 microns and 6 microns. In one implementation, the base mixture 100 can be emulsified with the proportion of oil during an emulsification period succeeding pasteurization of the base mixture 100. Alternatively, in another implementation, the base mixture 100 can be emulsified with the proportion of oil during an emulsification period preceding pasteurization of the base mixture 100.

During emulsification, the base mixture 100—and more specifically the proteins in the base mixture 100—can be heated to a temperature above their isoelectric point, a temperature at which the proteins are stable (e.g., stay in suspension in the mixture). During this heating process, the oil is emulsified into the base mixture 100 at a steady rate to achieve a stable emulsion between the aqueous phase 102 and the oil phase 104 of the base mixture 100.

In one implementation, the base mixture 100 is heated to a first target temperature before adding in the oil. Upon reaching the first target temperature, a first proportion of oil is added to the base mixture 100. For example, a canola oil can be added to prepare the base mixture 100 for processing into whipped cream; and a rice bran oil can be added to prepare the base mixture 100 for processing into hard cheese. By adding the oil at the first target temperature, stability of the aqueous phase 102 of the mixture may increase, thereby enabling emulsion of the oil into the aqueous mixture to occur more readily and more consistently. The temperature of the mixture is then further increased to a second target temperature (e.g., approximately 80 degrees Celsius) and held at this second target temperature for a target dwell time selected for the end product (e.g., between five and 27 minutes) such that the mixture is a homogeneous blend, stable, and fully emulsified. The temperature of the mixture is again increased to a peak temperature (e.g., approximately 75 degrees Celsius); additional flavorings specific to the end product may then be added to the mixture occupying this third target temperature. Adding these flavorings to the mixture upon reaching this peak temperature and toward the end of this emulsification process may limit degradation of these flavorings due to excess temperature exposure during this temperature ramp.

This addition of oil to the homogeneous aqueous mixture initiates the formation of micelles in the resulting plant-based, non-dairy milk substitute. In particular, the base mixture 100 includes ingredients and is processed to form micelles, which define microscopic structures that include hydrophobic and hydrophilic regions and are formed by aggregate surfactant molecules in aqueous solution, which enable the base mixture 100 to be transformed into many different forms, such as a non-dairy hard cheese, soft cheese, yogurt, cream, spread, ice cream, and/or butter, etc., much like (traditional) animal milk.

Therefore, these ingredients can be combined in a particular sequence, at specific temperatures, and under particular conditions according to the method S100 in order to enable and control micelle formation within the resulting base mixture 100. In particular, rather than rely on micelles that are naturally present—in varying concentrations—in animal milk (e.g., bovine milk) for functionality, and rather than filter or mix large batches of bovine milk in order to achieve consistent micelle concentrations across bovine milk products, the ingredients of the base mixture 100 can instead be combined according to the method to yield any volume of base mixture 100 (e.g., from 10 grams to 10 cubic meters) with a consistent concentration (e.g., +/−0.1% by volume) of micelles.

8.5 Variation: pH Regulation

In one variation, the base mixture 100 can include a proportion of a pH regulator configured to regulate pH of the base mixture 100 within a target pH range defined for the base mixture 100. In this variation, the proportion of the pH regulator can be added to the base mixture 100 upon completion of emulsification of the base mixture 100 to form the emulsion. The proportion of the pH regulator can therefore be selectively added to the emulsion (i.e., the base mixture 100) in order to maintain pH of the emulsion within the target pH range.

In one implementation, the base mixture 100 can include a proportion of the pH regulator corresponding to target characteristics—such as functionality, mouth-feel, flavor, etc. —defined for the base mixture 100 and/or corresponding to a particular non-dairy product.

In one example, a first batch of the base mixture 100 can be configured to form a non-dairy milk product. Further, the base mixture 100 can be configured to exhibit a pH within a pH range of 6.3 to 6.5. In this example, upon completion of emulsification to form the emulsion, a pH level of the emulsion (i.e., the base mixture) can be measured. Then, in response to the pH falling outside of the pH range, a proportion of a pH regulator—such as a potassium hydroxide solution configured to increase the pH or an acidifier configured to reduce the pH— can be added to the emulsion to selectively increase or decrease the pH to within the pH range, such as prior to pasteurization and/or homogenization. In this example, by maintaining the pH of the base mixture 100 within this pH range, the base mixture 100 can be configured to form the non-dairy milk product exhibiting a target functionality, such that the non-dairy milk product may be added to beverages of varying pH without exhibiting phase separation. In another example, a second batch of the base mixture 100 can be configured to form a non-dairy ice cream product. In this example, the base mixture 100 can be configured to exhibit a pH within a threshold deviation of 7.5. Then, in response to the pH level falling below and outside the threshold deviation of 7.5, a proportion of potassium hydroxide solution—such as a trace amount—can be added to the emulsion to increase the pH to within the threshold deviation of 7.5, such as prior to pasteurization and/or homogenization.

Homogenization

Following emulsification of the oil into the base mixture 100, the base mixture 100 can be homogenized in order to prevent phase separation and form the functionalized non-dairy base mixture 100. More specifically, the base mixture 100 is homogenized to achieve uniform particle distribution, particle size, fat globule distribution, and fat globule size, each of which may cooperate to prevent phase separation within the base mixture 100 and promote a consistent base mixture 100. The base mixture 100 can be configured to exhibit particle and fat distribution and sizes substantially similar to dairy counterparts.

In one variation, the base mixture 100 is cooled from higher temperatures during emulsification to lower temperatures (e.g., less than 40 degrees Fahrenheit) prior to homogenization of the base mixture 100.

The base mixture 100 can be homogenized within a set duration following emulsification, such as to limit reactions occurring between ingredients in the base mixture 100. For example, a proportion of amino acids may interact with sugar in the base mixture 100 to generate molotol at particular temperatures and over a period of time. Thus, the base mixture 100 can be homogenized rapidly following emulsification of the base mixture 100 to limit molotol generation (e.g., malty flavors) in the base mixture 100.

The base mixture 100 can be homogenized via a triple plate homogenizer at a set (e.g., relatively high) temperature. For example, the base mixture 100 can be homogenized via a triple plate homogenizer operating between 800-2200 psi. Alternatively, the base mixture 100 can be homogenized via ultrasonic homogenization or cavitation homogenization.

### 10. Cooling & Further Processing

Following homogenization, if not previously cooled, the base mixture 100 can be rapidly cooled from high temperatures during homogenization to lower temperatures (e.g., less than 40 degrees Fahrenheit). The base mixture 100 can be cooled via a heat exchanger. For example, the base mixture 100 can be run through a plate heat exchanger to reduce a temperature of the base mixture 100 from approximately (within 10 degrees Fahrenheit) 150 degrees Fahrenheit during homogenization to approximately (within 10 degrees Fahrenheit) 38 degrees Fahrenheit following cooling. The base mixture 100 can be cooled quickly (within a set duration following homogenization) in order to limit side reactions between ingredients (e.g., proline and sweeteners generating malt flavors).

In one variation, to produce a higher-order dairy product from the functional base mixture 100, such as a whipped cream or cheese, an acid can be added (e.g., in trace amounts) to the base mixture 100. Depending on the selected higher-order dairy product, the acid can be introduced before increasing the temperature of the base mixture 100 and emulsifying in the oil (e.g., cream cheese) or the acid can be introduced after emulsification and after the mixture is allowed to cool (e.g., frozen yogurt, feta cheese, or cheddar cheese). For example, a moderate proportion of acid (e.g., 0.2% by weight) can be added to the base mixture 100 when transforming the base mixture 100 into a soft cheese, and a smaller proportion of acid (e.g., 0.1% by weight) can be added to the base mixture 100 when transforming the base mixture 100 into a hard cheese or other end product.

10.1 Storing the Base Mixture

The resulting base mixture 100 can be further processed and/or stored according to a set of storage conditions defined for the base mixture 100. In particular, the base mixture 100 can define a set of storage conditions configured to: maximize a shelf-life of the base mixture 100; and maintain and/or promote a set of target characteristics—such as the target flavor profile, target functionality, target texture or “mouth feel”, etc. —of the base mixture 100.

In one variation, prior to packaging and/or storing of the base mixture 100, the base mixture 100 can be spray-dried to transform the base mixture 100 into a solid or powdered form. In this variation, the base mixture 100 can be reconstituted—such as by mixing the base mixture 100 with a volume of water—to return the base mixture 100 to a liquid or semi-liquid form.

In one implementation, to prevent destabilization of proteins in the proportion of plant-extracted proteins, the base mixture 100 can be: pasteurized via a low-temperature, high duration pasteurization process configured to limit destabilization of plant-extracted proteins (e.g., canola proteins); and then spray-dried—at relatively high temperatures—to transform the base mixture 100 from a liquid form to a powdered form. In this implementation, in order to limit a duration of exposure of the base mixture 100 to high temperatures, the base mixture 100 can be processed via this lower temperature pasteurization process. The base mixture 100 can then be further processed by spray drying the (liquid) base mixture 100—such as at relatively high temperatures —to yield the base mixture 100 in the powdered form and further extend the shelf life of the base mixture 100.

Additionally, in one implementation, the base mixture 100 can be mixed with a volume of a buffer solution matched to the base mixture 100 and then spray dried to generate a dried base mixture 100—such as the base mixture 100 in solid or powdered form—in preparation for storage. This dried base mixture 100 can then be stored according to a set of storage conditions defined for the base mixture 100, such as at temperatures within a target temperature range configured to maintain functionality, flavor, texture, and/or appearance of the base mixture 100—and/or the non-dairy product formed of the base mixture 100—for a target duration or “shelf life”. Additionally, in this implementation, a set of stabilizing agents (e.g., stabilizing ingredients) can be added to the base mixture and/or to the dried base mixture in order to prolong stability of the proportion of plant-extracted proteins. For example, various proteins or sugars can be added to the base mixture 100 and/or to the dried base mixture 100.

### 11. Forming the Non-Dairy Product

Once the base mixture 100 is generated—with varying concentrations of each base ingredient depending on the selected end product—and functionalized, the base mixture 100 can be stored at cool temperatures (e.g., less than 40 degrees Fahrenheit). Later, the base mixture 100 can be heated and mixed with various amounts of sheer and over various mixing times to transform the base mixture 100 into a particular end product. For example, the base mixture 100 can be loaded directly into an ice cream machine (e.g., including a Paco jet or liquid nitrogen dispenser)—such as an ice cream maker or soft serve ice cream maker configured to generate traditional, dairy ice cream or soft serve—to transform the base mixture 100 directly into a non-dairy (e.g., a “plant-based”) ice cream. In another example, the base mixture 100 can be acidified to produce a soft cheese, such as a feta cheese.

### 12. Non-Functional, Non-Dairy Milk Substitute

To produce a non-functional plant-based milk (e.g., to be consumed as a regular non-dairy milk substitute and not meant for transformation into other non-dairy products), the base mixture 100 does not need to complete micelle formation. For example, the base mixture 100—and more specifically the proteins in the base mixture 100—can be heated to a temperature above their isoelectric point, a temperature at which the proteins are stable (e.g., stay in suspension in the mixture). During this heating process, the oil is emulsified into the base mixture 100. Once the isoelectric point is reached, the base mixture 100 is stabilized, pasteurized, and then chilled. At this point, no flocculation has occurred in the base mixture 100, and the resulting non-dairy milk product (e.g., a low-order end product) is considered non-functional but may be consumed as non-dairy replacement for common milk (e.g., skim, 2%, or whole bovine milk).

This plant-based, non-dairy, non-functional milk product may thus function, taste, and yield a mouth feel similar to common bovine milk. For example, this milk product can be frothed to produce foam for certain milk-based drinks. This plant-based, non-dairy, non-functional milk product may also be added to other foods (e.g., a pasta sauce, scrambled eggs) without imparting flavors distinct from common bovine milk.

### 13. Functional, Non-Dairy Milk Substitute

The base mixture 100 can also be acidified to generate a plant-based, non-dairy, functional milk substitute. In particular, the addition of a small amount of acid (e.g., less than 0.2%) to the mixture functionalizes the plant-extracted protein.

Therefore, the base mixture 100 can include a proportion of an acid configured to functionalize the plant-extracted proteins. In particular, this proportion of the acid can be configured to neutralize polarity of canola proteins in the proportion of plant-extracted proteins (e.g., Canola proteins, potato proteins) present in the mixture and promote micelle formation between the proportion of plant-extracted proteins, the proportion of starches, and the volume of oil droplets.

For example, once the base mixture 100 is heated to a temperature at which the mixture reaches its isoelectric point, the base mixture 100 can be allowed to stabilize before cooling to a lower temperature, at which time the cooled base mixture 100 is acidified through the addition of a particular concentration of an acid or acidifier (e.g., lactic acid, citric acid, peroxyacetic acid, acetic acid, sodium acid sulfate) that lowers the pH of the base mixture 100. For example, sodium acid sulfate—which is not acidic—can be added to the base mixture 100 to lower its pH while amplifying salt and sugar flavors and without producing an acidic taste in the resulting end product.

After acidification, the base mixture 100 can be cooled to a lower temperature (i.e., less than its isoelectric point temperature) while mixed at a specific shear, to produce the functionalized non-dairy base with micelles.

The base mixture 100 can undergo rapid acidification via the addition of a first proportion of acid. The first proportion of acid can include: lactic acid; citric acid; sodium acid sulfate; or any combination of these acids. Rapid acidification can be implemented for making softer or spreadable cheeses (e.g., cream cheese). During rapid acidification, the base mixture 100 can be heated to a threshold temperature before addition of the first proportion of acid. Addition of the acid promotes micelle formation with the base mixture 100, which may then be cooled down for further processing. The acid can be added before emulsification of the oil into the base mixture 100.

Alternatively, the base mixture 100 can undergo slow acidification. After the base mixture 100 is cooled following homogenization, the base mixture 100 can undergo slow acidification via addition of a slow acidifier to the base mixture 100, such as a microbial rennet or a lactobacillus. Upon addition of this slow acidifier, the base mixture 100 expels water from the aqueous phase 102 out of the base mixture 100. The slow acidifier causes proteins in the base mixture 100 to lose charge and therefore expel water absorbed by these proteins. The proteins then bind with starches bound to oils in the oil phase 104, while the aqueous phase 102 separates out, forming curds. Thus, slow acidification can be implemented for making hard cheeses.

Again, depending on the end product, the sequence of steps in the process of acidification may be reordered. For example, when making a mozzarella cheese, the process is similar to the process for making cream cheese. Early acidification still occurs, but to a greater extent (e.g., with a higher acid concentration) in order to achieve a tighter bonded structure between the micelle molecules and therefore stronger curd formation during the flocculation process. The curds can then be placed in a salt water bath with a temperature of approximately 80-85 degrees Celsius. The curds can then be stretched into sheets of “mozzarella cheese”, before continuing the process.

### 14. Non-Dairy Frozen Desserts

Frozen desserts and certain whipped dairy products or spreadable cheeses may not fully complete the micelle formation process. Starting with the base mixture 100, an additional quantity of salt can be added to ensure the appropriate frozen dessert consistency. This modified base mixture 100 can be run through a soft-serve or ice cream machine to output the non-dairy frozen dessert alternative, without requiring any further processing, due to the functionalized plant-extracted protein. In one implementation, the base mixture 100 can include canola oil as the source of fats when making the base mixture 100 for alternative frozen dessert products, as micelle formation is not necessary and therefore an oil with a high saturated fat content is not needed. Also, because the dessert product will be either refrigerated or frozen, the oxidation will be very slow and the product will have a long shelf life. Alternatively, a different unsaturated fat or combination of unsaturated fats can be used. For example, if the selected product is a “lemon rosemary gelato”, a specific olive oil may be selected for emulsion into the base mixture 100, dependent on the flavor and texture of the dessert.

Ice cream end products (e.g., hard-packed ice cream, soft serve ice cream, gelato, etc.) can include varying proportions of salt, calcium, and sweeteners to control freezing point depression of the ice cream end product. Additionally, base mixture 100s for these products can include varying proportions of sweeteners to regulate freezing point depression. For example, the base mixture 100 can define an ice cream base mixture 100. The ice cream base mixture 100 can be characterized by a scoopability range defining a range of temperatures at which the ice cream base mixture 100 exhibits at least a threshold scoopability (e.g., as a function of force applied to scoop consistent, smooth, frozen ice cream). The ice cream base mixture 100 can: include a first proportion of salt 120, a first proportion of calcium 130, and a first proportion of sweetener 160s, each of which cooperate to regulate a freezing point range of the ice cream base mixture 100; exhibit a scoopability temperature range corresponding to the freezing point range; and define a sweetener ratio of a quantity of glucose to a quantity of sucrose between one and four. In this example, the ice cream base mixture 100 can regulate the freezing point range between twenty degrees Fahrenheit and thirty degrees Fahrenheit. The scoopability range corresponds to a temperature range in which ice cream exhibits a favorable texture and consistency for scooping (or serving) frozen ice cream without difficulty. A first subvolume of the ice cream base mixture 100 can: exhibit a first sweetener ratio of two; exhibit a first freezing point temperature within the freezing point range; and exhibit a first scoopability temperature range between ten degrees Fahrenheit and fifteen degrees Fahrenheit. A second subvolume of the ice cream base mixture 100 can: exhibit a second sweetener ratio of four; exhibit a second freezing point temperature less than the first freezing point temperature; and exhibit a first scoopability temperature range between five degrees Fahrenheit and ten degrees Fahrenheit. Thus, by increasing the ratio of sucrose to glucose in the ice cream base mixture 100, the ice cream base mixture 100 exhibits a lower freezing point temperature and higher scoopability (e.g., above the threshold scoopability) at lower temperatures.

The base ingredients can be combined at varying concentrations, depending on the selected end product. For example, when making a whipped cream product, the salt percentage in the base mixture 100 can be decreased to be significantly less than the salt percentage in the base mixture 100 for most other products, including ice cream or cheese. The lower salt percentage in the base mixture 100 allows a minimum protein gelation to achieve a similar texture and shape of regular whipped cream, while the proteins can still withhold air. If the salt content is lowered beyond a minimum threshold, the protein gelation will not occur, and the proteins cannot withhold air. Protein gelation is necessary for the end product formation in order for the product to have a specific shape, texture, and firmness. In regular dairy product production (e.g., whipped cream production), the fats in dairy milk hold the air. In this non-dairy product production, the proteins are manipulated to hold the air.

14.1 Example: Non-Dairy Frozen Dessert

In one example, the base mixture 100 can be configured to form a non-dairy frozen dessert (e.g., a non-dairy ice cream). In this example, the base mixture 100 can include: a proportion of water; a proportion of cane sugar; a proportion of low-erucic acid rapeseed oil; a proportion of modified food starches; a proportion of rapeseed protein; a proportion of tapioca maltodextrin; a proportion of tapioca syrup; a proportion of vanilla extract; a proportion of salt; a proportion of calcium lactate; and a proportion of calcium gluconate. In particular, these proportions of ingredients can be mixed to form an emulsion (e.g., a non-dairy emulsion excluding dairy proteins and/or dairy ingredients) configured to form a non-dairy frozen dessert. This emulsion can then be run through an ice cream maker—such as with or without inclusion of additional ingredients (e.g., for flavoring)—to form the non-dairy frozen dessert, which may then exhibit similar taste and texture to traditional dairy ice cream.

In one variation of this example, the base mixture 100 can be configured to form a non-dairy, vanilla frozen dessert (e.g., a non-dairy vanilla ice cream). In this variation, the base mixture 100 can additionally include a proportion of vanilla extract. Alternatively, in another variation of this example, the base mixture 100 can be configured to form a non-dairy, chocolate frozen dessert (e.g., a non-dairy chocolate ice cream). In this variation, the base mixture 100 can additionally include: a proportion of cocoa (e.g., processed with alkali); and/or a proportion of coffee extract. Alternatively, in another variation of this example, the base mixture 100 can be configured to form a non-dairy, “mint chip” frozen dessert (e.g., a non-dairy “mint chip” ice cream). In this variation, the base mixture 100 can additionally include: a proportion of dark chocolate (e.g., including cacao beans, cane sugar, cocoa butter, and/or vanilla beans); and/or a proportion of peppermint oil. In each of these variations of this example, the proportions of ingredients can be mixed and/or processed to form an emulsion (e.g., a non-dairy milk) which can then be transformed into a non-dairy frozen dessert by processing the emulsion within a standard ice cream maker.

### 15. Variation: Non-Dairy Spreadable and Soft Cheeses

Additional processing is necessary to form soft cheeses from the base product. The base mixture 100 includes the same ingredients, but may include different concentrations of these ingredients. The process also involves mixing the base mixture 100 at a higher shear than the process for producing non-functional milk. As the oil is emulsified into the base mixture 100, at a temperature near 70 degrees Celsius, the temperature is still increased until it reaches approximately 80 degrees Celsius. At this temperature, the mixture is then held for a first duration of time ranging from 5-27 minutes, depending on the end product. For a softer cheese, the duration of time held at this temperature can be shorter than the duration for a harder cheese. After the first duration, the temperature is again increased to approximately 85 degrees Celsius. Once this temperature is reached, various flavors can be added to the mixture depending on the specific end product. After addition of the flavors, the mixture can be rapidly chilled back down, via a plate exchanger system. At this point, the mixture can be used as a base mixture 100 or as an ice cream base. In order to achieve a soft cheese, a flocculation process must occur to produce curds in the mixture. This is achieved by acidification of the mixture, and then allowing the mixture to further cool in a refrigeration process. Additional cultures may be added for flavoring depending on the end product. For example, a certain culture may be added to the “cheese” to achieve a feta cheese flavor, whereas a different culture may be added to the “cheese” to achieve a Brie cheese flavor. A set of holding tanks can be used as the mixture flocculates and separates out the curds from the milk, which can be drained and collected as functional milk, or undergo further processing to produce other dairy products.

The acidification step can be performed at different times in the process, depending on the end product. For example, when making a spreadable cheese such as cream cheese, acidification occurs before the temperature ramp begins. In this implementation, before adding the oil and beginning the emulsification, the mixture is initially acidified, which causes the proteins and starches to bind more tightly. The oil, more specifically an oil-starch slurry, is then emulsified into this acidified mixture with the tightened protein and starch bonds, which forces the micelle formations

### 16. Variation: Non-Dairy Aged and Hard Cheeses

To make hard cheeses from the base mixture 100, the mixture must undergo additional processing. Although the initial process is similar, a slow acidification is implemented rather than the rapid acidification used when making the non-functional milk or softer cheeses. In this process, the base mixture 100 including the salt, calcium, starch, protein, sugars and flavor are mixed together accordingly, and the temperature ramp up is initiated. The speed of the mixture is increased as the temperature increases to get a higher shear. At approximately 70 degrees Celsius, the oil is emulsified into the mixture. For a hard cheese, the oil can be an oxidative stable oil with a high saturated fat content (e.g., a vegetable oil, or oils that are solid at room temperature). Once the oil is fully emulsified in the mixture and the temperature of the mixture reaches approximately 80 degrees Celsius, the mixture is allowed to continue mixing and homogenize for a certain duration (e.g., between 5 minutes and 27 minutes) and then again increased in temperature to approximately 85 degrees Celsius. At this temperature, the flavors for the specific type of hard cheese are added to the mixture (e.g., cheddar flavors for a “cheddar cheese”).

After the flavors are added and the emulsification process is complete, the mixture can be refrigerated and chilled to approximately 40-45 degrees Celsius, and can then undergo a slow acidification process. For example, a slow acidifier such as a microbial rennet or a lactobacillus may be added to the mixture so that micelles begin to form and the cheese is slowly formed. Excess water expels out of the bottom of the mixture, separating from the curds, allowing for cheese formation. The cheese can be chilled even further in the refrigerator, and additional cheese cultures may be added to the cheese for flavoring once the temperature reaches approximately 30-35 degrees Celsius. Additionally, depending on the end product, more ingredients may be added, such as additional salt if the selected cheese product is a “salty” cheese (e.g., mozzarella).

Again, depending on the end product, the sequence of steps in the process may be reordered. For example, when making a mozzarella cheese, the process is similar to the process for making cream cheese. Early acidification still occurs, but to a greater extent (e.g., with a higher acid concentration) in order to achieve a tighter bonded structure between the micelle molecules and therefore stronger curd formation during the flocculation process. The curds can then be placed in a salt water bath with a temperature of approximately 80-85 degrees Celsius. The curds can then be stretched into sheets of “mozzarella cheese”, before going through the rest of the process.

### 17. Example: Non-Dairy “Milk”

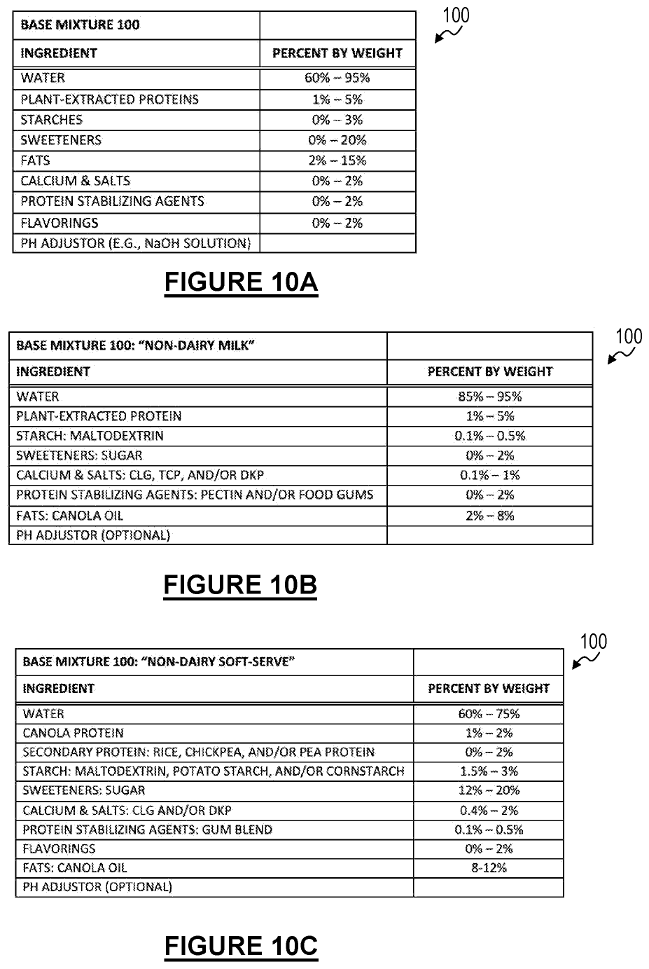

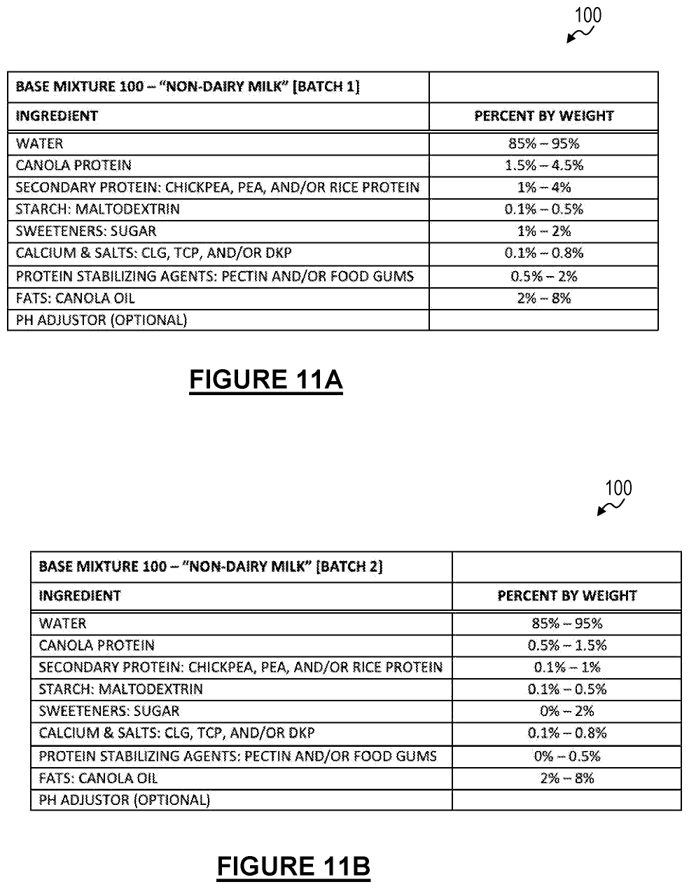

In one example, as shown in FIGS. 10B, 11A, and 11B, the base mixture 100 can form a non-dairy milk configured to exhibit similar taste, texture, nutritional value, and/or functionality as a dairy milk.

In this example, the base mixture 100 can include: a proportion of water; a proportion of plant-extracted proteins (e.g., canola proteins, chickpea proteins, pea proteins, rice proteins, potato proteins); a proportion of starches (e.g., maltodextrin); a proportion of sweeteners (e.g., sugar); a proportion of calcium and/or salts (e.g., CLG, TCP, DKP); a proportion of protein stabilizing agents (e.g., pectin, food gums); and a proportion of fat (e.g., canola oil). Additionally, the base mixture 100 can selectively include a proportion of a pH adjustor configured to regulate pH of the base mixture 100 within a target pH range, such as corresponding to a target functionality of the resulting non-dairy milk.

In particular, in this example, as shown in FIG. 10B, the base mixture 100 can include: a proportion of water defining a concentration between 85 percent and 95 percent by weight; a proportion of plant-extracted proteins (e.g., canola proteins, chickpea proteins, pea proteins, rice proteins, potato proteins) defining a concentration between 1 percent and 5 percent by weight; a proportion of starches (e.g., maltodextrin) defining a concentration between 0.1 percent 0.5 percent by weight; a proportion of sweeteners (e.g., sugar) defining a concentration between zero percent and 2 percent by weight; a proportion of calcium and/or salts (e.g., CLG, TCP, DKP) defining a concentration between 0.1 percent and 1 percent by weight; a proportion of protein stabilizing agents (e.g., pectin, food gums) defining a concentration between zero percent and 2 percent by weight; and a proportion of fat (e.g., canola oil) defining a concentration between 2 percent and eight percent by weight.

In this example, different batches of the base mixture 100 can be mixed to include varying concentrations of these ingredients—within the specific concentration ranges—to yield batches of the base mixture 100 exhibiting different characteristics. In one example, as shown in FIG. 1iA, a first batch of the base mixture 100—forming a first batch of a non-dairy milk—can include: a proportion of water defining a concentration between 85 percent and 95 percent by weight; a proportion of canola proteins defining a concentration between 1.5 percent and 4.5 percent by weight; a proportion of secondary proteins (e.g., chickpea, pea, rice) defining a concentration between 1 percent and 4 percent by weight; a proportion of starches defining a concentration between 0.1 percent and 0.5 percent by weight; a proportion of sweeteners defining a concentration between 1 percent and 2 percent by weight; a proportion of calcium and/or salts defining a concentration between 0.1 percent and 0.8 percent by weight; a proportion of stabilizing agents defining a concentration between 0.5 percent and 2 percent by weight; and a proportion of canola oil defining a concentration between 2 percent and 8 percent by weight.

In another example, as shown in FIG. 11B, a second batch of the base mixture 100—forming a second batch of a non-dairy milk—can include: a proportion of water defining a concentration between 85 percent and 95 percent by weight; a proportion of canola proteins defining a concentration between 0.5 and 1.5 percent by weight; a proportion of secondary proteins (e.g., chickpea, pea, rice) defining a concentration between 0.1 and 1 percent by weight; a proportion of starches defining a concentration between 0.1 percent and 0.5 percent by weight; a proportion of sweeteners defining a concentration between zero percent and 2 percent by weight; a proportion of calcium and/or salts defining a concentration between 0.1 percent and 0.8 percent by weight; a proportion of stabilizing agents defining a concentration between zero percent and 0.5 percent by weight; and a proportion of canola oil defining a concentration between 2 percent and 8 percent by weight. In these example, the first batch of the base mixture 100 can form a non-dairy milk product exhibiting a first set of characteristics, such as including: a first functionality characterized by a first degree of foaming capability; a first flavor profile characterized by a first degree of plant-extracted protein flavor (e.g., grassy flavor); and/or a first texture characterized by a first degree of variability. The second batch of the base mixture 100 can form a non-dairy milk product exhibiting a second set of characteristics, such as including: a second functionality characterized by a second degree of foaming capability less than the first degree of foaming capability; a second flavor profile characterized by a second degree of plant-extracted protein flavor less than the first degree of plant-extracted protein flavor; and/or a second texture characterized by a second degree of variability less than first degree of variability.

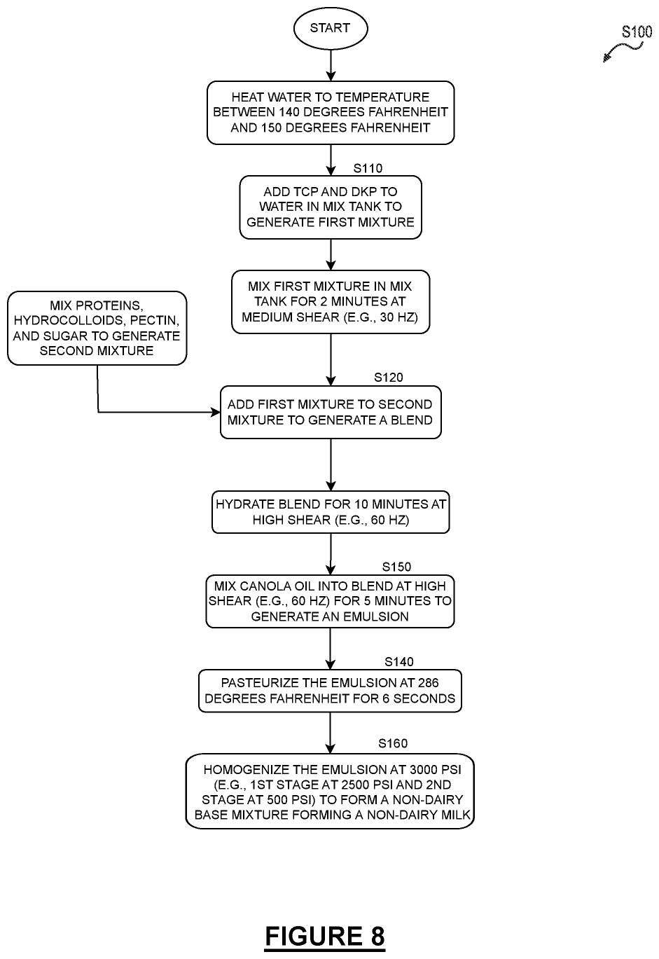

In this example, as shown in FIG. 8, the proportion of water can be heated to temperatures between 140-degrees Fahrenheit and iso-degrees Fahrenheit. The proportion of salts and/or the proportion of calcium can then be added to the proportion of water in a mixer to form a first mixture. The first mixture can then be mixed for two minutes at high shear (e.g., 30 Hz) for a duration of approximately ten minutes. Separately, the proportion of stabilizing agents, the proportion of sweeteners, the proportion of starches, and/or the proportion of plant-extracted proteins—including the proportion of canola proteins and the proportion of secondary proteins—can be mixed to form a second mixture. The second mixture can then be added to the first mixture to form a blend. The blend can then be mixed at high shear (e.g., 60 Hz) for a duration of approximately ten minutes

The proportion of oil can then be added to the blend and mixed at a high-speed (e.g., 60 Hz) for a duration of approximately 5 minutes to form an emulsion. Then, during a pasteurization period, the emulsion can be pasteurized (e.g., within a standard pasteurization machine) at approximately 286 degrees Fahrenheit (e.g., within 10 degrees Fahrenheit) for a duration of approximately 6 seconds to generate a pasteurized emulsion. The pasteurized emulsion can then be homogenized at approximately 3000 psi—such as including a first stage at approximately 2500 psi and a second stage at approximately 500 psi—to form a first batch of the base mixture 100. The base mixture 100 can then be cooled to a target temperature and packaged accordingly, such as in a standard gallon container for milk.

### 18. Example: Non-Dairy “Frozen Dessert”

In another example, as shown in FIG. 10C, the base mixture 100 can form a non-dairy frozen dessert (e.g., non-dairy ice cream, non-dairy soft-serve ice cream) configured to exhibit similar taste, texture, nutritional value, and/or functionality as a dairy ice cream.

In this example, as shown in FIG. 10C, the base mixture 100 can include: a proportion of water; a proportion of calcium; a proportion of salt; a proportion of starches (e.g., tapioca maltodextrin, potato starch); a proportion of plant-extracted proteins; a proportion of stabilizing agents; a proportion of sweeteners; a proportion of flavorings; and/or a proportion of fat. Additionally, the base mixture 100 can selectively include a proportion of a pH adjustor configured to regulate pH of the base mixture 100 within a target pH range, such as corresponding to a target functionality of the resulting non-dairy frozen dessert.

In one example, as shown in FIG. 10C, the base mixture 100 can include: a proportion of water defining a concentration between 60 percent and 75 percent by weight (e.g., 60 percent, 65 percent, 70 percent); a proportion of sweeteners (e.g., sugar) between 12 percent and 20 percent by weight (e.g., 12 percent, 15 percent, 18 percent); a proportion of starches (e.g., maltodextrin, potato starch, cornstarch) between 1.5 percent and 3 percent by weight; a proportion of plant-extracted proteins (e.g., canola, rice, chickpea, pea, potato) between 1 percent and 4 percent by weight, such as including a proportion of canola proteins between one percent and two percent by weight and a proportion of secondary proteins between zero percent and two percent by weight; a proportion of canola oil between 8 percent and 12 percent by weight (e.g., 8 percent, 10 percent, 12 percent); a proportion of flavorings between zero percent and 2 percent by weight; a proportion of stabilizing agents (e.g., arabic gum, tara gum, guar gum) between 0.1 percent and 0.5 percent (e.g., 0.5 percent); and/or a proportion of calcium and/or salts between 0.4 percent and 2 percent.

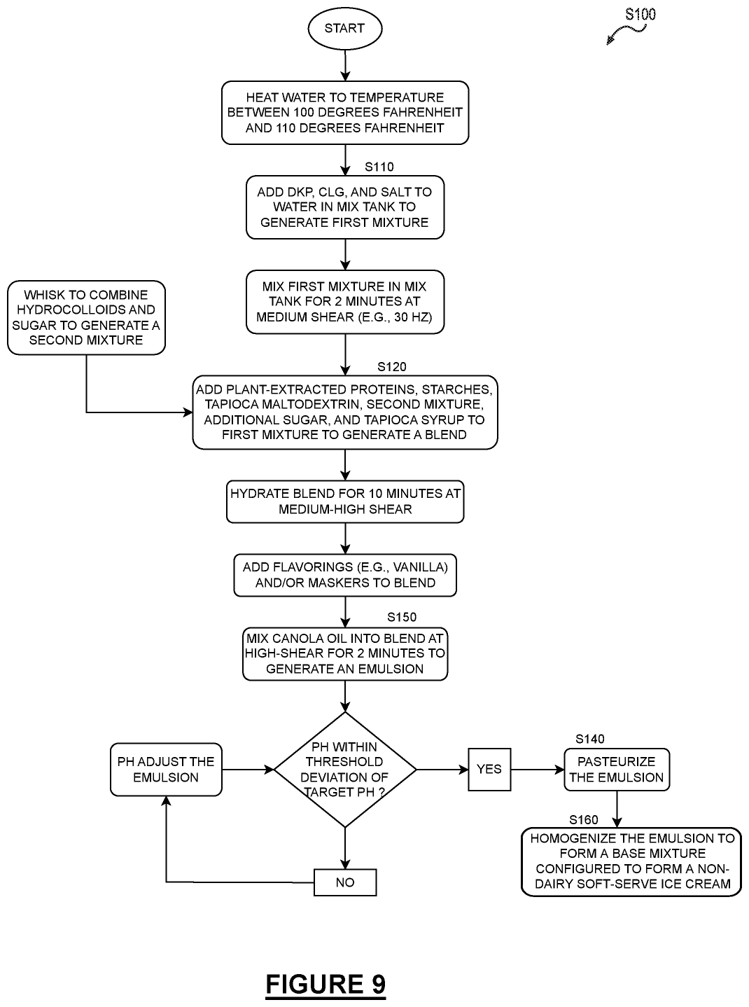

In this example, as shown in FIG. 9, the proportion of water can be heated to a temperature between 100-degrees Fahrenheit and no-degrees Fahrenheit. In a mixer, the proportion of salts and/or calcium (e.g., DKP, CLG, salt) can be added to the proportion of water to form a first mixture. The first mixture can then be mixed at moderate shear (e.g., 30 Hz) for a duration of approximately 2 minutes. Separately, the proportion of the stabilizing agents (e.g., a hydrocolloid blend) can be mixed (e.g., whisked) with the proportion of sweeteners (e.g., sugar) to form a second mixture. The proportion of plant-extracted proteins, the proportion of starches, a proportion of additional sweetener (e.g., sugar) and the second mixture can be added to the first mixture to form a blend. The blend can then be mixed at moderate shear (e.g., 30 Hz) during a hydration period of approximately 10 minutes. The proportion of flavorings can then be added to the third mixture. The proportion of oil can then be added to the third mixture and mixed at high-shear (e.g., 60 Hz) for a duration of approximately 5 minutes to form an emulsion.

Then, during a pasteurization period, the emulsion can be pasteurized (e.g., within a standard pasteurization machine) at approximately 286 degrees Fahrenheit for a duration of approximately 6 seconds to generate a pasteurized emulsion. The pasteurized emulsion can then be homogenized at approximately 3000 psi—such as including a first stage at approximately 2500 psi and a second stage at approximately 500 psi—to form a first batch of the base mixture 100. The base mixture 100 can then be cooled to a target temperature and packaged accordingly, such as in a standard gallon container for ice cream.

Additionally and/or alternatively, in this example, the base mixture 100 can include a proportion of a pH regulator (e.g., Potassium hydroxide) configured to regulate pH of the base mixture 100 within a threshold deviation of 7.5. In this example, the proportion of the pH regulator can be selectively added to the emulsion during a titration period preceding the pasteurization period, such as in response to the pH of the third mixture (i.e., the base mixture or emulsion) falling outside of a target pH range defined for the base mixture 100.

As a person skilled in the art will recognize from the previous detailed description and from the figures and claims, modifications and changes can be made to the embodiments of the invention without departing from the scope of this invention as defined in the following claims.

I claim:

1. A non-dairy base mixture comprising:
a blend comprising:
a proportion of water;
a proportion of salt;
a proportion of calcium;
a proportion of sweeteners;
a proportion of starches; and
a proportion of plant-extracted proteins:
comprising a first proportion of canola proteins and a second proportion of secondary proteins; and
defining a target ratio of the first proportion of canola proteins to the second proportion of secondary proteins, the target ratio corresponding to a target functionality and a target flavor profile; and
a proportion of fats:
comprising a volume of oil droplets dispersed throughout the blend; and
configured to cooperate with the proportion of plant-extracted proteins to form an emulsion:
excluding dairy proteins; and
configured to form a consumable, non-dairy product exhibiting the target functionality and the target flavor profile corresponding to a target dairy product.

2. The base mixture of claim 1, wherein the emulsion is configured to form the consumable non-dairy product comprising a non-dairy milk excluding dairy proteins and exhibiting the target flavor profile and the target functionality corresponding to a dairy milk.

3. The base mixture of claim 1:
wherein the proportion of canola proteins is configured to exhibit the target functionality defining:
a first set of binding properties;
a first set of gelling properties; and
a first set of foaming properties; and
wherein the proportion of secondary proteins is configured to exhibit the target flavor profile defining a first concentration of a first target volatile.

4. The base mixture of claim 1:
wherein the proportion of water defines a first concentration between 60 percent and 95 percent by weight;
wherein the proportion of salt defines a second concentration between zero percent and 1 percent by weight;
wherein the proportion of calcium defines a third concentration between zero percent and 1 percent by weight;
wherein the proportion of sweeteners defines a fourth concentration between zero percent and 20 percent by weight;
wherein the proportion of starches defines a fifth concentration between zero percent and 3 percent by weight;
wherein the proportion of plant-extracted proteins defines a sixth concentration between 1 percent and 5 percent by weight;
wherein the proportion of fats defines a seventh concentration between 2 percent and 15 percent by weight; and
wherein the blend further comprises a proportion of stabilizing agents configured to stabilize the proportion of plant-extracted proteins and defining an eighth concentration between zero percent and 2 percent by weight.

5. The base mixture of claim 1:
comprising a first volume comprising the blend comprising the proportion of plant-extracted proteins defining the target ratio corresponding to the target functionality and the target flavor profile of the consumable, non-dairy product;
comprising a second volume comprising:
a second blend comprising:
a second proportion of water;
a second proportion of salt;
a second proportion of calcium;
a second proportion of sweeteners;
a second proportion of starches; and
a second proportion of plant-extracted proteins:
comprising a third proportion of canola proteins and a fourth proportion of secondary proteins; and
defining a second target ratio of the third proportion of canola proteins to the fourth proportion of secondary proteins, the second target ratio corresponding to a second target functionality and a second target flavor profile; and
a second proportion of fats:
comprising a second volume of oil droplets dispersed throughout the second blend; and
configured to cooperate with the second proportion of plant-extracted proteins to form a second emulsion:
excluding dairy proteins; and
configured to form a second consumable, non-dairy product exhibiting the second target functionality and the second target flavor profile corresponding to a second target dairy product.

6. The base mixture of claim 5:
wherein the blend further comprises a first proportion of a first set of stabilizing agents configured to stabilize the first proportion of canola proteins, the first set of stabilizing agents corresponding to the target functionality;
wherein the emulsion is configured to form a consumable, non-dairy milk exhibiting the target functionality and the target flavor profile corresponding to a dairy milk;
wherein the second proportion of plant-extracted proteins defines the second target ratio, of the third proportion of canola proteins to the fourth proportion of canola proteins, exceeding the target ratio of the first proportion of canola proteins to the second proportion of canola proteins;
wherein the second blend further comprises a second proportion of a second set of stabilizing agents configured to stabilize the third proportion of canola proteins, the second set of stabilizing agents corresponding to the second target functionality; and
wherein the second emulsion is configured to form a consumable, non-dairy ice cream exhibiting the second target functionality and the second target flavor profile corresponding to a dairy ice-cream.

7. The base mixture of claim 1, wherein the proportion of plant-extracted proteins comprising the first proportion of canola proteins and the second proportion of secondary proteins comprises the proportion of plant-extracted proteins comprising the first proportion of canola proteins and the second proportion of secondary proteins comprising chickpea proteins.

8. The base mixture of claim 1, wherein the proportion of plant-extracted proteins comprising the first proportion of canola proteins and the second proportion of secondary proteins comprises the proportion of plant-extracted proteins comprising the first proportion of canola proteins and the second proportion of secondary proteins comprising rice proteins.

9. The base mixture of claim 1, wherein the proportion of plant-extracted proteins defining the target ratio of the first proportion of canola proteins to the second proportion of secondary proteins comprises the proportion of plant-extracted proteins defining the target ratio of the first proportion of canola proteins to the second proportion of secondary proteins between one and two.

10. The base mixture of claim 1:
wherein the first proportion of canola proteins is configured to impart the target functionality to the consumable, non-dairy product, the target functionality corresponding to the target dairy product; and
wherein the second proportion of secondary proteins is configured to impart the target flavor profile and a target texture to the consumable, non-dairy product, the target flavor profile and the target texture corresponding to the target dairy product.

11. The base mixture of claim 1, wherein the blend further comprises a proportion of stabilizing agents configured to:
stabilize the first proportion of canola proteins in the emulsion during high-temperature-short-time pasteurization of the emulsion; and
cooperate with the first proportion of canola proteins in the consumable, non-dairy product to maintain the target functionality of the consumable, non-dairy product.

12. The base mixture of claim 1, wherein the blend further comprises a proportion of an acid configured to neutralize polarity of canola proteins in the proportion of canola proteins and promote micelle formation between the proportion of canola proteins, the proportion of starches, and the volume of oil droplets.

13. A base mixture comprising:
a proportion of water defining an aqueous phase;
a proportion of salt dissolved in the aqueous phase;
a proportion of calcium dissolved in the aqueous phase;
a proportion of sweeteners;
a proportion of fats defining an oil phase comprising a volume of oil droplets dispersed throughout the aqueous phase;
a proportion of plant-extracted proteins configured to form a barrier between oil droplets of the oil phase and the aqueous phase to form an emulsion;
a proportion of starches configured to stabilize the emulsion;
a proportion of stabilizing agents configured to stabilize the proportion of plant-extracted proteins in the emulsion; and
wherein the emulsion excludes dairy proteins and is configured to form a consumable non-dairy product excluding dairy proteins.

14. The base mixture of claim 13:
comprising a first volume comprising the emulsion configured to form the consumable, non-dairy product;
comprising a second volume comprising:
a second proportion of water defining a second aqueous phase;
a second proportion of salt dissolved in the second aqueous phase;
a second proportion of calcium dissolved in the aqueous phase;
a second proportion of sweeteners;
a second proportion of fats defining a second oil phase comprising a second volume of oil droplets dispersed throughout the second aqueous phase;
a second proportion of canola proteins configured to form an interface between oil droplets of the oil phase and the aqueous phase to form a second emulsion; and
a second proportion of starches configured to stabilize the second emulsion; and
a second proportion of stabilizing agents configured to stabilize the proportion of plant-extracted proteins in the emulsion; and
wherein the second emulsion is configured to form a second consumable, non-dairy product excluding dairy proteins.

15. The base mixture of claim 13:
wherein the proportion of plant-extracted proteins:
comprises a first proportion of canola proteins and a second proportion of secondary proteins; and
defines a target ratio of the first proportion of canola proteins to the second proportion of secondary proteins, the target ratio corresponding to:
a target functionality profile defining a set of binding properties, a set of gelling properties, and a set of foaming properties; and
a target flavor profile defining a first concentration of a target volatile; and
wherein the emulsion is configured to form the consumable non-dairy product exhibiting the target functionality profile and the target flavor profile.

16. A method comprising:
during a preparation period:
mixing a first set of ingredients to generate a first mixture, the first set of ingredients comprising a volume of water, an amount of salt, and an amount of calcium; and
mixing a second set of ingredients into the first mixture to generate a second mixture, the second set of ingredients comprising an amount of starches, an amount of plant-extracted proteins, and an amount of stabilizing agents configured to stabilize the amount of plant-extracted proteins, the amount of plant-extracted proteins comprising a first amount of canola proteins and a second amount of secondary proteins mixed at a protein ratio corresponding to a target functionality and a target flavor profile;
during a blending period succeeding the preparation period:
regulating temperature of the second mixture within a first temperature range; and
blending a volume of oil into the second mixture to form an emulsion comprising a dispersion of oil droplets within the volume of water;
during a pasteurization period succeeding the blending period, pasteurizing the emulsion at temperatures within a second temperature range and for a first duration;
during a homogenization period succeeding the pasteurization period, homogenizing the emulsion at temperatures within a third temperature range and for a second duration to form a base mixture configured to form a consumable, non-dairy product exhibiting the target functionality and the target flavor profile.

17. The method of claim 16, further comprising during a processing period succeeding the homogenization period:
spray-drying a volume of the base mixture to transform the base mixture from a liquid state to a solid state; and
packaging the base mixture in the solid state for storage.

18. The method of claim 16:
wherein mixing the second set of ingredients into the first mixture to generate the second mixture comprises mixing the second set of ingredients into the first mixture to generate the second mixture, the second set of ingredients comprising the amount of starches, the amount of plant-extracted proteins, and the amount of stabilizing agents configured to stabilize the first amount of canola proteins at temperatures within the second temperature range; and
wherein pasteurizing the emulsion at temperatures within the second temperature range for the first duration comprises pasteurizing the emulsion at temperatures within the second temperature range, between 170 degrees Fahrenheit and 285 degrees Fahrenheit, and for the first duration less than 25 seconds.

19. The method of claim 18:
wherein mixing the second set of ingredients into the first mixture to generate the second mixture comprises mixing the second set of ingredients into the first mixture to generate the second mixture, the second set of ingredients comprising the amount of starches, the amount of plant-extracted proteins, and the amount of stabilizing agents configured to stabilize the first amount of canola proteins at temperatures within the second temperature range, the amount of stabilizing agents comprising an amount of pectin; and
wherein pasteurizing the emulsion at temperatures within the second temperature range for the first duration comprises pasteurizing the emulsion at approximately 190 degrees Fahrenheit and for the first duration of 20 seconds.

20. The method of claim 16:
wherein homogenizing the emulsion to form the base mixture comprises homogenizing the emulsion to form a first volume of the base mixture configured to form the consumable, non-dairy product exhibiting the target functionality and the target flavor profile;
during a second preparation period:
mixing a third set of ingredients to generate a third mixture, the third set of ingredients comprising a volume of water, an amount of salt, and an amount of calcium; and
mixing a fourth set of ingredients into the third mixture to generate a fourth mixture, the fourth set of ingredients comprising an amount of starches, an amount of plant-extracted proteins, and an amount of stabilizing agents configured to stabilize the proportion of plant-extracted proteins, the amount of plant-extracted proteins comprising a third amount of canola proteins and a fourth amount of secondary proteins mixed at a second protein ratio corresponding to a second target functionality and a second target flavor profile;
during a second blending period succeeding the second preparation period:
regulating temperature of the fourth mixture within the first temperature range; and
blending a second volume of oil into the fourth mixture to form a second emulsion comprising a dispersion of oil droplets within the volume of water of the fourth mixture;
during a second pasteurization period succeeding the second blending period, pasteurizing the second emulsion at temperatures within the second temperature range and for the first duration; and
during a second homogenization period succeeding the second pasteurization period, homogenizing the emulsion at temperatures within the third temperature range and for the second duration to form a second volume of the base mixture configured to form a second consumable, non-dairy product exhibiting the second target functionality and the second target flavor profile.
